(19) United States
(12) Patent Application Publication
(10) Pub. No.: US 2020/0380202 A1
(43) Pub. Date: Dec. 3, 2020

(54) SYSTEMS AND METHODS OF ELECTRONIC FORM MANAGEMENT

(71) Applicant: Nest Wealth Asset Management Inc., Toronto (CA)

(72) Inventors: Phillip Randall Cass, Toronto (CA); David Patrick Briand, Toronto (CA); Tyler John Franklin Post, Burlington (CA); Craig Neable, Toronto (CA)

(73) Assignee: Nest Wealth Asset Management Inc., Toronto (CA)

(21) Appl. No.: 16/882,798

(22) Filed: May 26, 2020

Related U.S. Application Data
(60) Provisional application No. 62/853,110, filed on May 27, 2019.

(51) Int. Cl. G06F 40/186; G06F 16/22; G06F 40/174

(52) U.S. Cl. CPC G06F 40/186; G06F 40/174; G06F 16/22

(57) ABSTRACT

Systems and methods of electronic form management are provided. An electronic form management method and system may receive a first candidate form for mapping and generation of a first equivalent form template. An electronic form management method and system may collect user data and may receive a plurality of user inputs, which may collectively be stored in a structured data set. An intermediate document is generated based on the user inputs, and a form document is output based on the intermediate document. An electronic form management method and system may generate multiple form documents for output to different books of record. An electronic form management method and system may receive a validation rule change request, and test the electronic form for compliance.

### CROSS-REFERENCE TO RELATED APPLICATIONS

This application claims the benefit of U.S. Provisional Application No. 62/853,110 filed on May 27, 2019, which is incorporated by reference herein in its entirety.

### FIELD

The described embodiments relate to electronic form management.

### BACKGROUND

Business process managers face many problems when integrating software applications with legacy systems, such as banking systems, Book of Record (BOR) systems, and other legacy business processes and systems. Similarly, the management of medical records may require the integration with legacy systems for personal health records.

One problem is the reliance on completed paper forms (or electronic representations of a completed paper form) as the single source of truth (SSOT) for the submission of information including official documents. The requirements for paper forms and electronic representations of these forms include compliance requirements for organizations that have internal compliance controls (for example, financial institutions including banks).

In large information systems (including form management systems), the reliance on paper forms as the SSOT for legacy systems is problematic because these formats are not readily linked to a digital representation of the form data. Reliance on digital representations of the paper forms (such as Portable Document Format (PDF) files) is problematic because the digital representation is not easily verified in an automated manner and is highly susceptible to changes in the underlying form. The digital representation is easily exchanged, but it is not considered a SSOT, so exchanging it does not provide the necessary confidence in the data. As such, existing digital form representations do not allow for the efficient exchange of information with BOR systems.

Another problem is that in existing electronic representations of paper forms (such as fillable PDF files), data collection from users is independent of the digital representation and is instead based only on the electronic representation of the paper form. This means that data collection is performed on a per-field basis for the electronic representation of the form, and pre-existing data from a different BOR may not be re-used because the data is mapped based on the fields for each electronic form. This may lead to asking users for information the system may already have. This per-field data collection is inefficient because it does not allow pre-existing user data to pre-populate fields on the electronic forms, nor does it allow efficient data sharing.

Another problem is that electronic forms requires extensive maintenance effort. An electronic form may be updated repeatedly, for example when the BOR requires form revisions as its requirements change. These existing form implementations require extensive testing because of the strict compliance requirements of the BOR. Revisions to the electronic form to add or remove form fields, change input or business validation rules, etc, introduce significant risks because of vendor compliance requirements. Vendors have a very low risk tolerance for incorrect electronic form submissions.

### SUMMARY

In accordance with aspects of this invention, there are methods and systems of managing electronic documents to address the above problems.

One aspect includes a method and system where a candidate form is submitted, and a mapping is generated between a structured data set and the form fields on the candidate form. The mapping is used to generate an equivalent form template of the candidate form, allowing for efficient electronic form generation.

Another aspect includes a method and system having structured user data set that functions as a SSOT and is output corresponding with a form document. The structured user data set is a digital representation of the form data on the form document and allows for the efficient exchange of information.

Another aspect includes a method and system that can automatically validate changes to validation rules of a BOR. This automated testing of the validation rules makes the maintenance of electronic forms more efficient.

In a first aspect, some embodiments of the invention provide a method of electronic form management, comprising: receiving a first candidate form; determining a first plurality of form fields on the first candidate form; determining a first mapping from the first plurality of form fields on the first candidate form to a structured data set; storing the first mapping of the first plurality of form fields on the first candidate form to the structured user data set; generating a first equivalent form template based on the first plurality of form fields, the first mapping of the first plurality of form fields and the structured user data set.

In at least one embodiment, the method may further comprise: receiving a second candidate form; determining a second plurality of form fields on the second candidate form; determining a second mapping from the second plurality of form fields on the second candidate form to a structured data set; storing the second mapping of the second plurality of form fields on the second candidate form to the structured user data set; generating a second equivalent form template based on the second plurality of form fields, the second mapping of the second plurality of form fields and the structured user data set.

In at least one embodiment, at least one of the first plurality of form fields on the first equivalent form template and at least one of the second plurality of form fields on the second equivalent form template may map to a same user data element in the structured data set.

In at least one embodiment, the method may further comprise: pre-populating a user data field in the second plurality of form fields based on the same user data element in the structured data set.

In at least one embodiment, the first mapping of the first plurality of form fields on the first candidate form and the second mapping of the second plurality of form fields on the second candidate form may be bidirectional mappings.

In at least one embodiment the first equivalent form template and the second equivalent form template may each have a same form type.

In at least one embodiment the first equivalent form template and the second equivalent form template may each have a different form type.

In at least one embodiment the first equivalent form template may be a new application form type and the second equivalent form template may be a new account form type.

In a second aspect, some embodiments of the invention provide a system of electronic form management, comprising: a memory; a processor configured to: receive a first candidate form; determine a first plurality of form fields on the first candidate form; determine a first mapping from the first plurality of form fields on the first candidate form to a structured data set; store the first mapping of the first plurality of form fields on the first candidate form to the structured user data set in the memory; generate a first equivalent form template based on the first plurality of form fields and the structured user data set.

In at least one embodiment, the system may further comprise: the processor may be further configured to: receive a second candidate form; determine a second plurality of form fields on the second candidate form; determine a second mapping from the second plurality of form fields on the second candidate form to a structured data set; store the second mapping of the second plurality of form fields on the second candidate form to the structured user data set in the memory; generate a second equivalent form template based on the second plurality of form fields and the structured user data set.

In at least one embodiment, the at least one of the first plurality of form fields on the first equivalent form template and at least one of the second plurality of form fields on the second equivalent form template may map to a same user data element in the structured data set.

In at least one embodiment, the system may further comprise: the processor may be further configured to: pre-populate a user data field in the second plurality of form fields based on the same user data element in the structured data set.

In at least one embodiment, the first mapping of the first plurality of form fields on the first candidate form and the second mapping of the second plurality of form fields on the second candidate form may be bidirectional mappings.

In at least one embodiment, the first equivalent form template and the second equivalent form template may each have a same form type.

In at least one embodiment, the first equivalent form template and the second equivalent form template may each have a different form type.

In at least one embodiment, the first equivalent form template may be a new application form type and the second equivalent form template may be a new account form type.

In a third aspect, some embodiments of the invention provide a method of electronic form management, comprising: storing a plurality of user inputs in a structured user data set; generating an intermediate document based on the plurality of user inputs; outputting a form document based on the intermediate document; and outputting the structured data set.

In at least one embodiment, the method may further comprise: receiving a request to complete a form document from a user; presenting a data entry page having a plurality of fields to the user; and in response to the data entry page submission, receiving a plurality of user inputs corresponding to the plurality of fields, each field in the plurality of fields may have a key and a value corresponding to the key.

In at least one embodiment, each user data in the plurality of user input may have at least one category.

In at least one embodiment, the at least one category may be one of a mandatory category, a conditional category, and an optional category.

In at least one embodiment, the structured data set may be stored in a database.

In at least one embodiment, the storing the plurality of user input in the structured user data set may comprise updating an existing structured data set in the database.

In at least one embodiment, the intermediate document may be rendered in a markup language.

In at least one embodiment, the intermediate document may be an XML document format.

In at least one embodiment, the intermediate document may be an HTML document format.

In at least one embodiment, the method may further comprise: generating an output form document from the intermediate document.

In at least one embodiment, the output form document may be a PDF format document.

In a fourth aspect, some embodiments of the invention provide a system for electronic form management, comprising: a processor configured to: store a plurality of user inputs in a structured user data set; generate an intermediate document based on the plurality of user inputs; and validate the plurality of user inputs on the intermediate document by comparing at least one user input value in the plurality of user input of the intermediate document with the value identified by the user input key in the structured data set.

In at least one embodiment, the system may further comprise: the processor may be further configured to: receive a request to complete a form document from a user; present a data entry page having a plurality of fields to the user; and in response to the data entry page submission, receive a plurality of user inputs corresponding to the plurality of fields, each field in the plurality of fields may have a key and a value corresponding to the key.

In at least one embodiment, the processor may be further configured to: output the form document based on the intermediate document; and output the structured data set.

In at least one embodiment, the intermediate document may be rendered in a markup language.

In at least one embodiment, each user data in the plurality of user input may have at least one category.

In at least one embodiment, the at least one category may be one of a mandatory category, a conditional category, and an optional category.

In at least one embodiment, the system may further comprise: the memory may further comprise: a database; the processor may be further configured to: store the structured data set in the database.

In at least one embodiment, the processor may be further configured to update an existing structured data set in the database.

In at least one embodiment, the intermediate document may be an XML document format.

In at least one embodiment, the intermediate document may be an HTML document format.

In at least one embodiment, the form document may be a PDF document format.

In a fifth aspect, some embodiments of the invention provide a method of electronic form management, comprising: storing a plurality of user inputs in a structured user data set; generating a first form document based on the plurality of user inputs; generating a second form document based on the plurality of user inputs; and outputting the first form document, the second form document, and the structured data set.

In at least one embodiment, the method may further comprise: receiving a data entry request from a user; presenting a data entry page having a plurality of fields to the user; and in response to the data entry page submission, receiving a plurality of user inputs corresponding to the plurality of fields, each user input may have a key and a value corresponding to the key.

In at least one embodiment, the method may further comprise: providing a first plurality of validation rules associated with the first form document; providing a second plurality of validation rules associated with the second form document; executing the first plurality of validation rules on the first form document to determine a first validation result; executing the second plurality of validation rules on the second form document to determine a second validation result; and outputting the first validation result and the second validation result.

In at least one embodiment, the first form document may correspond to a first vendor and the second form document may correspond to a second vendor.

In a sixth aspect, some embodiments of the invention provide a system of electronic form management, comprising: a processor configured to: store a plurality of user input in a structured user data set; generate a first form document based on the plurality of user inputs in a first format; generate a second form document based on the plurality of user inputs in a second format; and output the first form document, the second form document, and the structured data set.

In at least one embodiment, the system may further comprise a processor configured to: receive a data entry request from a user; present a data entry page having a plurality of fields to the user; and in response to the data entry page submission, receive a plurality of user inputs corresponding to the plurality of fields, each user input having a key and a value corresponding to the key.

In at least one embodiment, the processor may be further configured to: provide a first plurality of validation rules associated with the first form document; provide a second plurality of validation rules associated with the second form document; execute the first plurality of validation rules on the first form document to determine a first validation result; execute the second plurality of validation rules on the second form document to determine a second validation result; and output the first validation result and the second validation result.

In at least one embodiment, the first form document may correspond to a first vendor and the second form document may correspond to a second vendor.

In a seventh aspect, some embodiments of the invention provide a method of electronic form management, comprising: receiving a validation rule change request from a user for an electronic form; presenting a validation rule change page to the user for the electronic form; in response to the validation rule change page submission, receiving an updated validation rule for the electronic form; associating the updated validation rule with the electronic form; testing the electronic form document based on the updated validation rule.

In at least one embodiment, the testing may further comprise: executing a plurality of test cases, each test case may have an expected value, a test key, and test code, by, for each test case in the plurality of test cases: generating a test intermediate document; executing the test code; and comparing the value of the test intermediate document field associated with the test key of the test case with the expected value of the test case.

In at least one embodiment, the expected value of the test case may be the value of a field in the structured data set corresponding to the test key.

In at least one embodiment, the method may further comprise: outputting a positive test result if and only if the expected value matches the value of the intermediate document field associated with the test key and otherwise outputting a negative test result.

In an eighth aspect, some embodiments of the invention provide a system of electronic form management, comprising: a memory comprising: an electronic form having at least one validation rule; a processor configured to: receive a validation rule change request from a user for the electronic form; present a validation rule change page to the user for the electronic form; in response to the validation rule change page submission, receive an updated validation rule for the electronic form; associate the updated validation rule with the electronic form; test the electronic form document based on the updated validation rule.

In at least one embodiment, the system may further comprise: the memory may further comprise: a plurality of test cases, each test case having an expected value, a test key, and test code; the processor may be further configured to: execute the plurality of test cases, by, for each test case in the plurality of test cases: generating a test intermediate document; executing the test code; and comparing the value of the test intermediate document field associated with the test key of the test case with the expected value of the test case.

In at least one embodiment, the expected value of the test case may be the value of a field in the structured data set corresponding to the test key.

In at least one embodiment, the processor may be further configured to output a positive test result if and only if the expected value matches the value of the intermediate document field associated with the test key.

### BRIEF DESCRIPTION OF THE DRAWINGS

A preferred embodiment of the present invention will now be described in detail with reference to the drawings, in which:

FIG. 1A is a system diagram for managing electronic forms.

FIG. 1B is a workflow diagram for managing electronic forms.

FIG. 2A is a block diagram of the web server from FIG. 1A.

FIG. 2B is a block diagram of the test server from FIG. 1A.

FIG. 2C is a block diagram of the form server from FIG. 1A.

FIG. 3 is a data architecture diagram for managing electronic forms.

FIG. 4 is a data architecture diagram for managing electronic forms.

FIG. 5 is a form diagram for a legacy system.

FIG. 6 is a form diagram for a legacy system.

FIG. 7 is a method diagram for managing electronic forms.

FIG. 8 is a user interface diagram for managing electronic forms.

FIG. 9 is an object relationship diagram for managing electronic forms.

FIG. 10 is a method diagram for managing electronic forms.

FIG. 11 is an example instance of a form document for the BOR A.

FIG. 12 is an example instance of a form document for the BOR B.

FIG. 13 is an example of a structured data set for managing electronic forms.

FIG. 14 is a method diagram for managing electronic forms.

FIG. 15A is an example instance of a form document for the BOR A.

FIG. 15B is a method diagram for managing electronic forms.

FIG. 16 is an example instance of a form document for the BOR A.

FIG. 17 is an example instance of a form document for the BOR A.

FIG. 18 is a system diagram for managing electronic forms.

FIG. 19 is a system diagram for managing electronic forms.

FIG. 20 is an example instance of a form document for the BOR A.

FIG. 21 is an example instance of a form document for the BOR A.

### DESCRIPTION OF EXAMPLE EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and any combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact discs, tapes, chips, wireline transmissions, satellite transmissions, internet transmission or downloads, magnetic and electronic storage media, digital and analog signals, and the like. The computer useable instructions may also be in various forms, including compiled and non-compiled code.

The design of information systems such as database systems and distributed software applications is based on an efficient and correct representation. As a matter of best practice, it is recognized that structured information models and data schema should be designed such that data elements are stored exactly once in a SSOT. In the design of these informational models, connections to data stored in other schema, other databases, or other documents is done by reference only, to avoid the existence of multiple sources of truth that may pose a risk of duplicated and incorrect information.

As referred to herein, a candidate form refers to a form submitted by a user to the electronic form management system for modelling as an equivalent electronic form.

As referred to herein, an equivalent form template refers to a manifestation of the candidate form in the electronic form management system, such that it may create an instance of a form document when combined with a structured data set.

An instance of a form document may refer to an intermediate document or a form document that is generated by the electronic form management system and includes information from a structured data set.

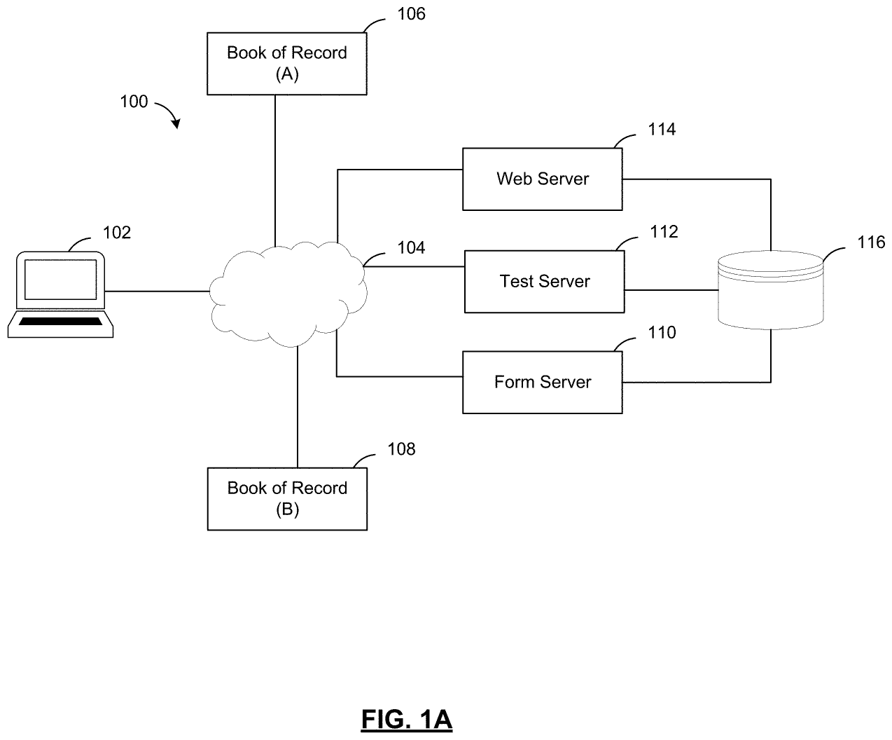

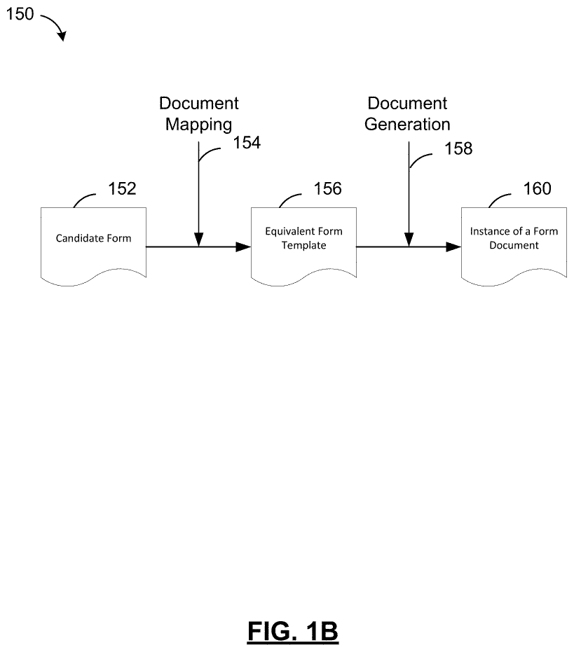

Referring to FIG. 1B, showing a workflow diagram 150 of an electronic form management system. From a high level, the workflow diagram 150 shows how an existing candidate form 152 is converted into an digital equivalent form template 156 by document mapping 154. The document mapping 154 may be performed by a user who submits the candidate form and maps the form fields to elements in the schema of a structured user data set, creating a mapping and an equivalent form template 156. The equivalent form template 156 may be created in a template language.

The equivalent form template 156 is used during document generation 158 to create an instance of a form document 160. During document generation a structured user data set associated with a user may be provided as input to the equivalent form template to create an instance of the form document that has the data within the structured user data set filled in the form fields on the instance of the form document 160.

Reference is first made to FIG. 1A, which illustrates an electronic form management system 100. The system 100 has a plurality of user devices, represented by user device 102, network 104, a BOR A 106, a BOR B 108, form server 110, test server 112, web server 114 and database 116.

User device 102 may be used by an end user to access an application (not shown) running on web server 114 over network 104. For example, the application may be a web application, a client/server application. The user device 102 may be a desktop computer, mobile device, or laptop computer. The user device 102 may be in communication with web server 114, test server 112, and form server 110. The user device 102 may display the web application, and may allow a user to register for financial products, including financial products from the BOR A 106 and the BOR B 108. The user at user device 102 may also be an administrator user who may administer the configuration and mapping of electronic forms using a web application at web server 114.

In another embodiment, the user device 102 may display the web application, and may allow a medical practitioner user to request electronic health information (including sending orders, requesting test results, sending patient records, etc), including electronic patient medical records from the BOR A 106 and the BOR B 108.

Network 104 may be a communication network such as the Internet, a Wide-Area Network (WAN), a Local-Area Network (LAN), or another type of network. Network 104 may include a point-to-point connection, or another communications connection between two nodes.

The BOR A 106 may be a financial institution directly involved with the electronic form management system 100. Alternatively, the BOR A 106 may be a financial institution indirectly involved with the electronic form management system 100, for example BOR A 106 may be an external organization such as a partner organization or partner bank. The BOR A 106 may implement an Application Programming Interface (API) to provide an endpoint that allows the electronic form management system 100 to transmit electronic forms and structured data sets. The BOR A 106 may accept electronic forms as email attachments, or the electronic forms may be provided on physical media that are shipped to the premises of BOR A 106. The BOR A 106 may use the electronic form submissions to create or update accounts at the financial institution.

In another embodiment, the BOR A 106 may be a medical organization involved in the storage, use, or processing of patient health records. The medical organization may be directly associated with the electronic form management system 100. Alternatively, the BOR A 106 may be a medical organization indirectly involved with the electronic form management system 100, for example, BOR A 106 may be an testing facility or a medical clinic not directly associated with the electronic form management system 100. The BOR A 106 may implement an Application Programming Interface (API) to provide an endpoint that allows the electronic form management system 100 to transmit electronic medical forms and structured data sets. The API may provide for communication of electronic medical records in a standard format such as an Electronic Data Interchange (EDI) format like Accredited Standards Committee X12 format, or European Committee for Standardization (CEN) format like International Standards Organization (ISO) 13606. The BOR A 106 may accept electronic forms as email attachments, or the electronic forms may be provided on physical media that are shipped to the premises of BOR A 106. The BOR A 106 may use the electronic form submissions to create or update patient records.

The BOR B 108 may be a financial institution directly involved with the electronic form management system 100. Alternatively, the BOR B 108 may be a financial institution indirectly involved with the electronic form management system 100, for example the BOR B 108 may be an external organization such as a partner organization or partner bank. The BOR B 108 may provide an API endpoint that allows the electronic form management system 100 to transmit electronic forms and structured data sets. The BOR B 108 may accept electronic forms as email attachments, or the electronic forms may be provided on physical media that are shipped to the premises of the BOR B 108. The BOR B 108 may use the electronic form submissions to create or update accounts at the financial institution. The BOR A 106 and the BOR B 108 may be third-parties from each other, and may be different financial institutions.

In another embodiment, the BOR B 108 may be a medical organization involved in the storage, use, or processing of patient health records. The medical organization may be directly associated with the electronic form management system 100. Alternatively, the BOR B 108 may be a medical organization indirectly involved with the electronic form management system 100, for example, BOR B 108 may be an testing facility or a medical clinic not directly associated with the electronic form management system 100. The BOR B 108 may implement an Application Programming Interface (API) to provide an endpoint that allows the electronic form management system 100 to transmit electronic medical forms and structured data sets. The API may provide for communication of electronic medical records in a standard format such as an Electronic Data Interchange (EDI) format like Accredited Standards Committee X12 format, or European Committee for Standardization (CEN) format like International Standards Organization (ISO) 13606. The BOR B 108 may accept electronic forms as email attachments, or the electronic forms may be provided on physical media that are shipped to the premises of BOR B 108. The BOR B 108 may use the electronic form submissions to create or update patient records.

The form server 110 is in communication with the database 116, test server 112, and web server 114. A user may access the form server 110 to perform the mapping of candidate forms, and generation of instances of form documents. The form server 110 may automatically map the candidate form. Mapping may involve determining required fields, optional fields, and conditional fields, and associating a key with the field. The key may refer to an element of a structured data set that may be stored in the database 116.

The form server 110 may accept as input a candidate electronic form. The candidate electronic form may be in a wide variety of formats, such as a Portable Document Format (PDF) file, an image file such as the Joint Photographic Experts Group (JPEG) or a Portable Network Graphics (PNG) file. The file may be in a text-based format such as a file encoded in a markup language such as Hyper Text Markup Language (HTML) or eXtensible Markup Language (XML), or another format.

The form server 110 may provide functionality for a user to map a candidate form. When the candidate electronic form is mapped, a mapping may be generated from the form fields on the candidate form and the structured data set. This mapping associates the form fields with elements of the structured data set. The mapping may be used to generate an equivalent form template corresponding to the candidate form, the equivalent form template may generally resemble the candidate form. The equivalent form may be described in a template language, and may use the mapping to identify the source element of the structured data set associated with each field.

The form server 110 may store an equivalent form template in the database 116. A request may be made to the form server 110 to generate an electronic form for a particular instance of a structured data set stored in the database 116.

The form server 110 may generate output, including a structured data set. The structured data set may be provided in a variety of different formats, such as JavaScript Object Notation (JSON) or eXtensible Markup Language (XML). The form server 110 may generate an intermediate output document, for example in a markup language such as XML or HTML. The form server 110 may generate a PDF output file including information from the structured data file.

The test server 112 may operate to test the form server 110 to determine the correctness of the equivalent form templates and the BOR compliance rules. The testing may be performed using test cases stored in the database 116, test data in the database 116, expected results in the database 116, or against values stored in a structured data set stored in database 116. This testing may be performed to determine the correctness of generated instances of electronic forms against the structured data set, allowing the structured data set to be treated as the SSOT of the system 100. A test case may have test data including a test structured data set that may be applied to an equivalent form template to produce an instance of an electronic document used for testing.

The web server 114 may host a web application or an API endpoint that the user device 102 may interact with via network 104. The web application at web server 114 may make calls to the form server 110, the database 116, and the test server 112. For example, a user may provide personal information and submit a request at the web application on the web server 114, and the web application may call the form server 110 to produce an instance of an electronic form.

The database 116 may store user information including structured data sets, electronic form mappings, and other electronic form information. The database 116 may be a Structured Query Language (SQL) such as PostgreSQL or MySQL or a not only SQL (NoSQL) database such as MongoDB. The database 116 may further store a plurality of test cases that include test code.

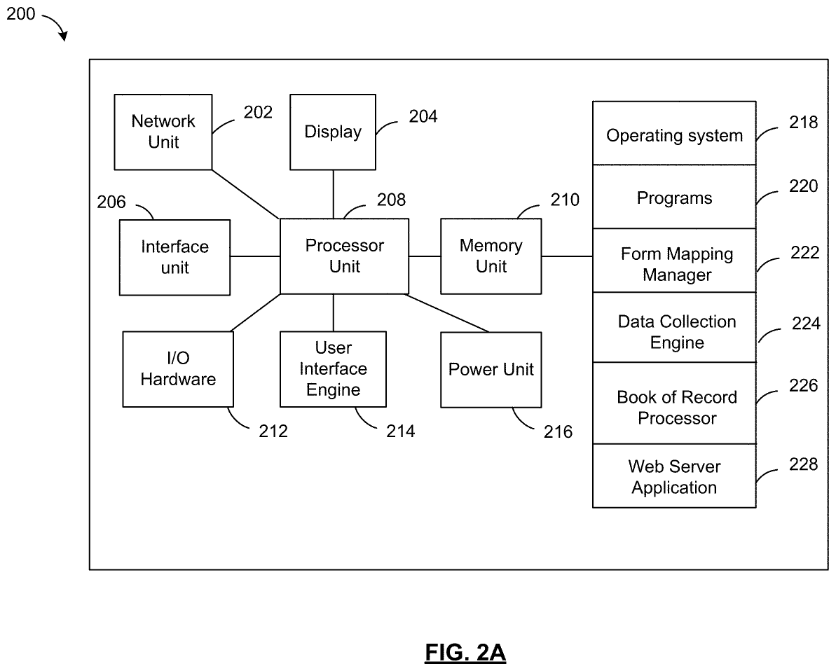

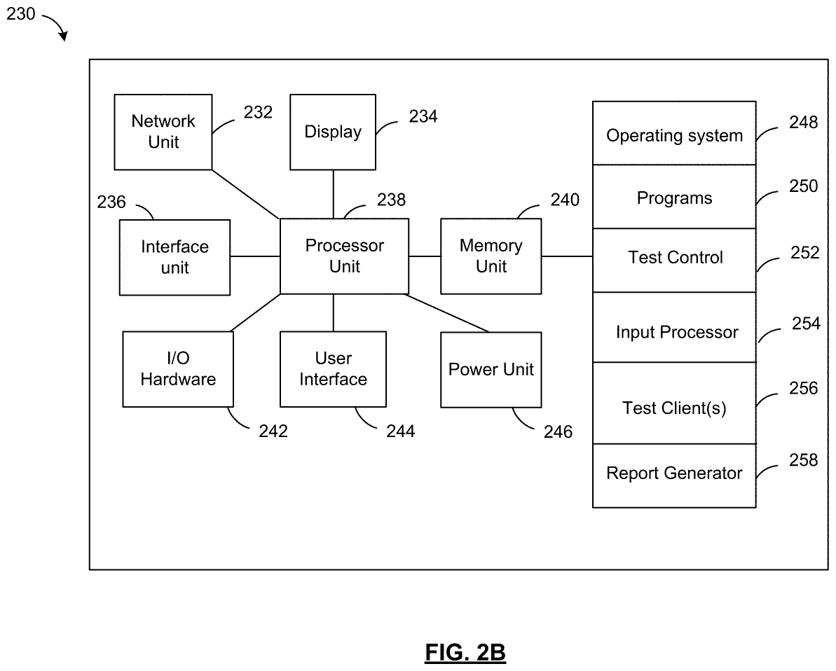

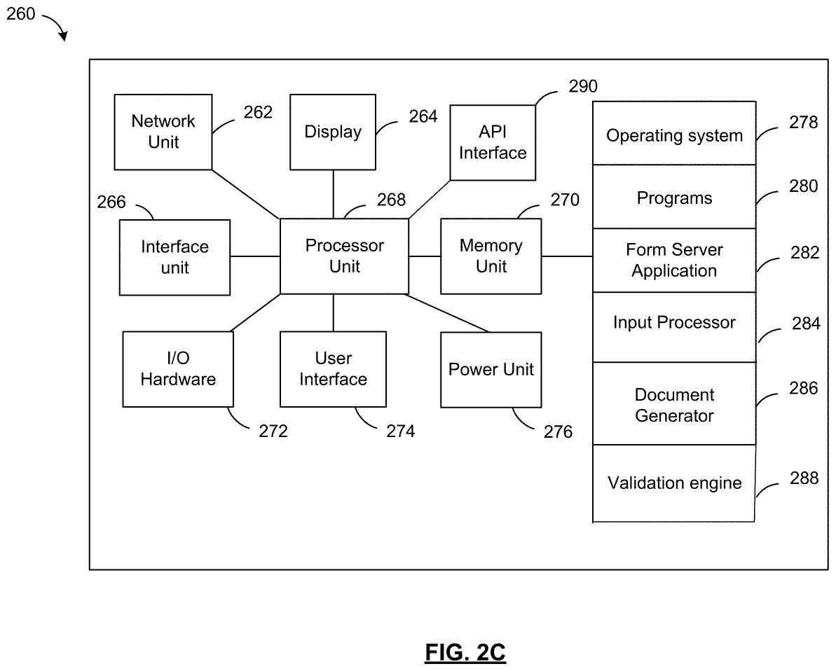

Reference is next made to FIG. 2A, showing a block diagram 200 of the web server 114 from FIG. 1A. The web server 200 has network unit 202, display 204, interface unit 206, processor unit 208, memory unit 210, I/O hardware 212, user interface 214, and power unit 216. The memory unit 210 has operating system 218, programs 220, a form mapping manager 222, data collection engine 224, a BOR processor 226, and a web server application 228.

For FIGS. 2A-2C, like numerals refer to like elements, such as the network unit 202, display 204, interface unit 206, processor unit 208, memory unit 210, I/O hardware 212, user interface 214, power unit 216, and operating system 218.

The network unit 202 may be a standard network adapter such as an Ethernet or 802.11x adapter. The processor unit 208 may include a standard processor, such as the Intel Xeon processor, for example. Alternatively, there may be a plurality of processors that are used by the processor unit 208 and may function in parallel.

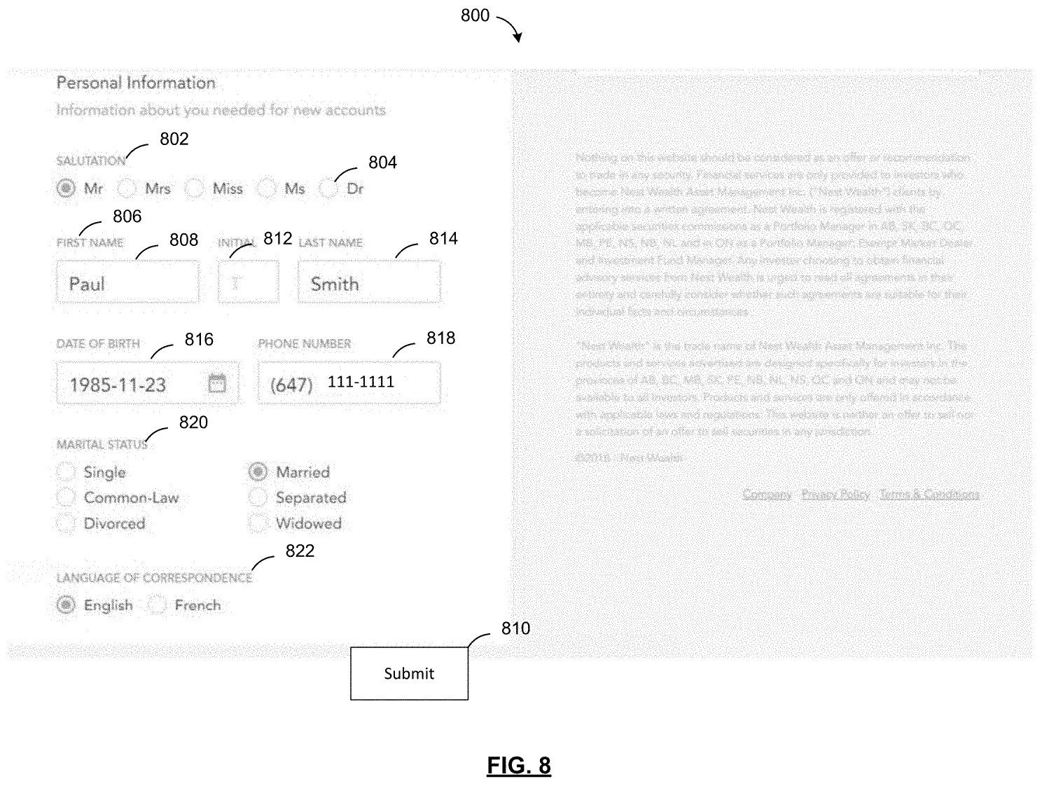

The processor unit 208 can also execute a graphical user interface (GUI) engine 214 that is used to generate various GUIs, some examples of which are shown and described herein, such as in FIG. 8. The user interface engine 214 provides for data collection layouts for users to enter electronic form information, and the information may be processed by the data collection engine 224. The user interface engine 214 provides for electronic form mapping layouts for users to map form fields to fields in a structured data set. User interface 214 may be an Application Programming Interface or a Web-based application that is accessible via the network unit 202.

Memory unit 210 may have an operating system 218, programs 220, a form mapping manager 222, a data collection engine 224, a BOR processor 226 and web server application 228.

The operating system 218 may be a Microsoft Windows Server operating system, or a Linux-based operating system, or another operating system.

The programs 220 comprise program code that, when executed, configures the processor unit 208 to operate in a particular manner to implement various functions and tools for the web server 200.

The form mapping manager 222 provides functionality for a user to map the fields of an electronic form to a structured data set. This may be performed by a user submitting a candidate electronic form, determining a plurality of form fields on the candidate form, and then creating a mapping of each field on the electronic form to a structured data set. The electronic form may be an application form, or the like.

The data collection engine 224 may receive data from users using the web application on the webserver, and may populate a structured data set associated with the user. The data collection may take different forms, and may include unstructured data collection that may collect different information at different times from users. The data collection engine 224 may also query API endpoints to retrieve information about users. For example, the data collection engine may (subject to a user's authorization) connect to a Canadian Revenue Agency API endpoint to collect data to populate the structured data set. The data collection engine 224 may also connect to other API endpoints to retrieve other information about users. The data collection engine 224 may provide for the parsing of the collected data and the parsing of metadata associated with the collected data. Both the collected data and the collected metadata associated with the data collection engine 224 may be stored in the structure data set associated with the user in the database.

The BOR processor 226 may send and receive data from different books of record. This may include API integrations with a variety of different books of record. The BOR processor 226 may also apply an equivalent form template, a form mapping and a structured data set to generate an instance of an electronic form document to be sent to the BOR. Referring to FIG. 1A, there are two books of record shown (A and B), but there may be more than two. Referring back to FIG. 2A, the BOR processor may parse output to be sent to a BOR, including parsing the structured data set, and instances of electronic documents, prior to sending them to the BOR.

The web server application 228 provides a web application for users accessible via network unit 202. The web server application 228 allows administrator users to upload candidate electronic forms, and use the form mapping manager 222 to associate a plurality of form fields with a structured data set. The web server application 228 also provides questions to users and performs data collection to populate instances of the structured data set. The populated structured data sets may be stored in a database.

I/O hardware 212 provides access to server devices including disks and peripherals. The I/O hardware provides local storage access to the programs running on web server application 228.

The power unit 216 provides power to the web server 200.

In another embodiment, the functionality of web server 200, including the form mapping manager 222, the data collection engine 224, the Book of Record Processor 226, and the Web Server Application 228 may be provided using a “serverless” architecture, such as the one provided by Amazon® Web Services (AWS®) Lambda® or others as are known.

Referring next to FIG. 2B, a block diagram 230 of the test server 112 from FIG. 1A is shown. The test server 230 has network unit 232, display 234, interface unit 236, processor unit 238, memory unit 240, I/O hardware 242, user interface 244, and power unit 246.

The memory unit 240 has operating system 248, programs 250, a test control application 252, an input processor 254, test clients 256, and a test report generator 258.

The programs 250 comprise program code that, when executed, configures the processor unit 238 to operate in a particular manner to implement various functions and tools for the test server 230.

The test control application 252 manages the test clients 256 (also referred to as the test system), and configures the test client to execute the test scripts stored in the database 116 (see FIG. 1A). There may be one or more test clients 256. There may be a plurality of test scripts stored in the database 116 (see FIG. 1A). The test control application 252 may also configure the form server 110 (see FIG. 1A) to perform testing. While testing is being performed, the form server 110 (see FIG. 1A) may be referred to as the system under test, or application under test. The test control application 252 may also perform testing each time an electronic form is generated by the form server 110 (see FIG. 1A). The test control application 252 may also perform testing each time an electronic form is modified.

The input processor 254 parses and processes the structured data sets, generated electronic forms (including intermediate forms), and other data as required. The test scripts in the database 116 (FIG. 1A) may further define actions for the input processor 254 to perform while under test.

The test clients 256 are client test environment(s), and may be virtual machines, test threads, or test processes that may be configured by test control application 252 as a client test environment for performing the testing of an electronic form. The test clients 256 may be integrated with the test control 252 automatically and may be operated based upon code in the test scripts in database 116 (FIG. 1A). The test clients may be local to the test server 230 or may be accessible over a network connection and hosted remotely. The test clients 256 may be instances of a browser application such as Mozilla Firefox, Google Chrome, or Internet Explorer. The test clients 256 may be “headless” browsers such as PhantomJS.

The report generator 258 prepares test summary results from the execution of the test scripts in the database 116 (see FIG. 1A), on the test clients 256. These test results may be formatted or marked-up so they may be human-readable. The report generator 258 may prepare the test results to be sent via email to an administrator user.

In another embodiment, the functionality of test server 230, including the test control 252, input processor 254, test clients 256, and report generator 258 may be provided using a “serverless” architecture, such as the one provided by Amazon® Web Services (AWS®) Lambda® or others as are known.

Reference is next made to FIG. 2C, showing a block diagram 260 of the form server 110 from FIG. 1A. The block diagram 260 of the form server has memory unit 270, the memory unit having programs 280, form server application 282, input processor 284, and document generator 286.

The programs 280 comprise program code that, when executed, configures the processor unit 268 to operate in a particular manner to implement various functions and tools for the form server 260.

The form server application 282 may provide an application that allows users to manage electronic forms. This application may be a web application, or a client server application, or another type of application. This application allows a user to map candidate forms to create mappings and equivalent form templates. The application 282 may also automatically map candidate forms.

The form server application 282 may also implement an API and provide an API endpoint for BORs or other organizations to communicate with the electronic form management system.

The validation engine 288 operates to apply validation rules to electronic form documents. The validation engine 288 may also enable a user to change validation rules associated with an electronic form. These validation rules may take two forms, input validation and business validation. Input validation refers to the validation of user inputs and business validation refers to the validation of business requirements of a BOR. These validation rules may be stored in the database 116 (see FIG. 1A), and may function to test the input/output data to the form server application 282 for business requirements of the BOR. These business requirements may include the length of data, the format of data, security considerations related to data format (for example, limitations related to SQL-injection or Cross-Site Scripting (XSS) attacks), the presence or absence of data conditional on other data, etc.

Input processor 284 queries database 116 (FIG. 1A) for data related to an instance of an electronic form. The input processor 284 may request the form mapping and structured data set from the database, and may further communicate with other services of a BOR to collect required data for the instance of the electronic form. The input processor 284 parses the structured data set for a particular user for the form server application 282 and for document generator 286. For testing purposes, the test server may provide the input processor 284 testing input data.

Document generator 286 takes a form mapping and the output of the input processor 284 and generates an instance of an electronic form document. The document generator communicates with the input processor 284 to populate the instance of the electronic form with data from the structured data set. The instance of the electronic form document corresponds to the structured data set (with the structured data set being the SSOT). The document generator 286 may generate an intermediate document based on the form mapping and the structured data set. The intermediate document may be in a markup language such at Hyper-Text Markup Language (HTML) or eXtensible Markup Language (XML). The document generator 286 may further generate a PDF file based upon the form mapping and the structured data set. The generated intermediate document may be used by the test server to determine compliance testing results based on a known input data set. Document generator 286 may generate an intermediate document based on a plurality of user inputs in a structured data set that is retrieved from the database 116 (see FIG. 1A) and processed by the input processor 284.

In another embodiment, the functionality of form server 260, including the form server application 282, the input processor 284, the document generator 286, and the validation engine 288 may be provided using a “serverless” architecture, such as the one provided by Amazon® Web Services (AWS®) Lambda® or others as are known.

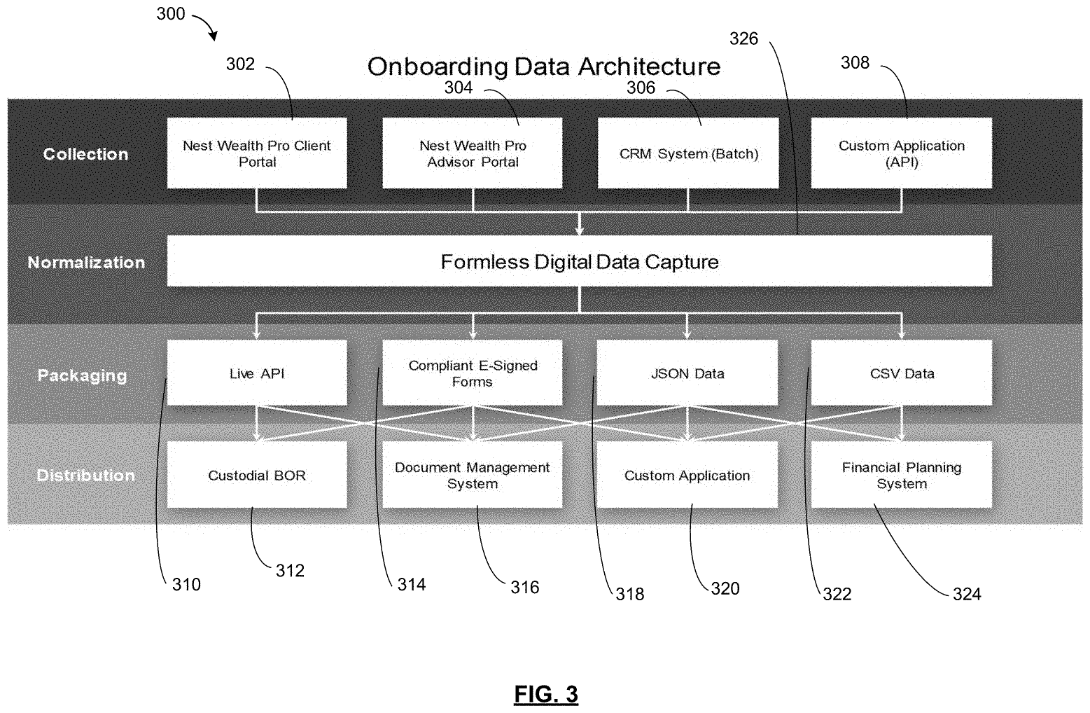

Referring to FIG. 3, there is a data architecture diagram 300 for managing electronic forms. As individuals are brought onboard as users of a software application for managing electronic forms, the data architecture has four main components: data collection, data normalization, data packaging, and data distribution.

Data collection may include (but is not limited to) a client portal 302, an advisor portal 304, a customer-relationship management (CRM) system 306, or an API endpoint 308. The data collection components 302-308 accept user data and store it in the database. Client portal 302 may be a self-serve web application hosted by web server 114 (FIG. 1A) where individuals can access data collection functionality and complete required data. Advisor portal 304 allows an advisor user representing a client or a user to collect and update information about the user. CRM 306 is a customer relationship management tool that may have pre-existing user information that may be imported individually, or in a batch, into the electronic form management system. CRM 306 may be Salesforce.com, SAP AG, or CRM applications from Oracle or other competitors. Data collection may be based upon user submissions, may be a pull type request where a user provides an identifier for a BOR service and the system pulls user data associated with the identifier over a network, or a push type request, where a BOR makes a request to API endpoint 308 including new or updated user data.

Data normalization may involve analysis of the data provided by a user and the form mappings in the database. The normalization may determine data on one or more electronic forms in the collected data from a user. The normalization may further determine information still outstanding based on one or more electronic forms and request additional data from the user. This outstanding user information may be collected via formless digital data capture 326, or collected on a rendition of the equivalent form template.

Data packaging may include a Live API endpoint 310, compliant e-signed forms 314, JavaScript Object Notation (JSON) data 318 (for example, in a json file), and Comma-Separated Values (CSV) data 322. The data packaging may prepare artifacts (such as an intermediate file or a PDF form), along with a structured data set (such as JSON data or CSV data). Live API endpoint 310 may be a REpresentation State Transfer Application Programming Interface (REST API) that may enable 3^{rd} parties to request structured data sets, intermediate forms, and instances of electronic forms (for example in PDF format). The format of the API endpoint response may vary, and may include a file download, JSON data, CSV data, XML data, or the like. Data may be packaged using an e-signed form 314 such as a signed PDF form. The e-signed form 314 may be in a format compliant with the party's internal compliance rules. The packaged data may be a structured data set, an intermediate file, a final output file (such as a PDF file), or a combination of a structured data set and an intermediate file or a combination of a final output file and a structured data set. The data may be packaged using a markup such as JSON data 318, CSV data 322, or XML data (not shown).

Data distribution may include distribution to a BOR 312, distribution to a document management system (DMS) 316, distribution to a custom application 320, distribution to a medical organization (in the case of electronic personal health records), and distribution to a financial planning system 324. The distribution of packaged data may be provided to a plurality of parties, and each party may have a different format. For example, packaged data may be distributed to several different BORs, and the format of the packaged data that is distributed to each BOR may be based upon a particular form mapping and the compliance rules of each particular BOR. Packaged data may be distributed to a DMS 316, using a provided API endpoint, or another means. The distribution of packaged data may be provided to a custom application 320, such as a web application. Packaged data may be distributed to a financial planning system 324 such as Mint, Quicken or Freshbooks. Packaged data may be distributed to a medical organization system (not shown), such as a private testing facility, a specialist clinic, or another medical practitioner.

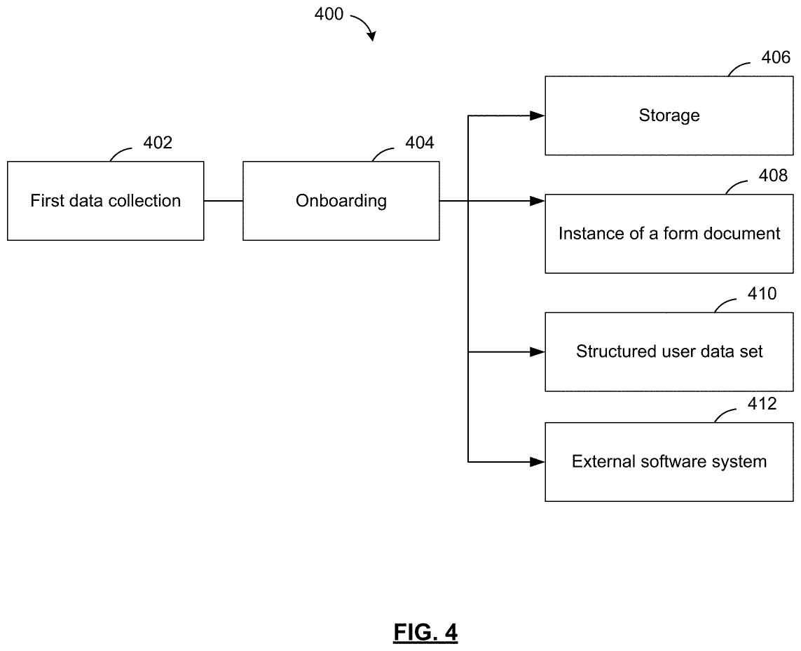

Referring to FIG. 4, there is a data architecture diagram 400 for managing electronic forms. The architecture for formless digital onboarding has first data collection 402, where data for a user is collected using an initial collection process. This data collection 402 may involve integration with BOR software systems for pre-population of a structured data set for a user. This structured data set may be described as a portable onboarding data format, and may include data collected about the user and relevant metadata. The data collection and normalization informs onboarding activity at 404, where a user is asked questions and answers are collected. The questions provided may be contextual based on the data collected at 402, and upon the data entered by the user during onboarding 404.

The onboarding 404 may include applying input validation rules based on at least one BOR or other data distribution. The input validation rules may provide rules for fitness, accuracy, and consistency for user data provided (either during data collection 402 or during the onboarding 404) into the electronic form management system.

The input validation performed during onboarding 404 may include data-type validation, range and constraint validation, code and cross-reference validation, and structured validation. Data-type validation rules are used to ensure that user input corresponds to the correct expected data type. For example, in a field where a user is required to input their gross annual income, an input validation rule may exist to check that the user's input in the field is a number. Range and constraint validation rules are used to check the user's input is within a maximum and minimum range. For example, the user's net income should not exceed their gross income. Cross-reference validation rules may involve checking the user's input during onboarding to determine if they match values found elsewhere. Structured validation allows for combinations of the other validation rules listed above.

The onboarding 404 may create a structured data set for a user that is considered a SSOT. The SSOT is a single data structure that defines the correct information for the user.

The structured data set (reflecting a SSOT) may be exported to storage 406. The storage of the structured data set may be in a database (such as database 116 in FIG. 1A), or to disk. The structured user data set may be used to generate an intermediate document (for example, in a markup format such as HTML), and an instance of a form document (for example, in a format such at PDF) 408. The structured data set may be submitted to a BOR 410, and may be submitted with an intermediate or output file to the BOR. The electronic form management system may integrate with an external software system 412 to transmit the structured data set.

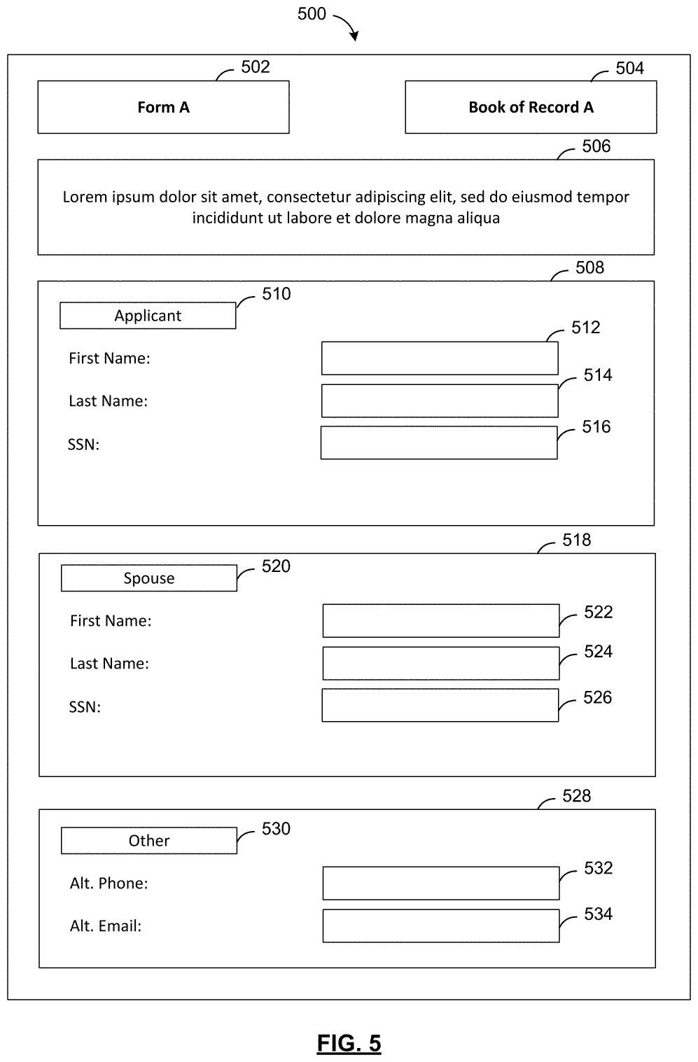

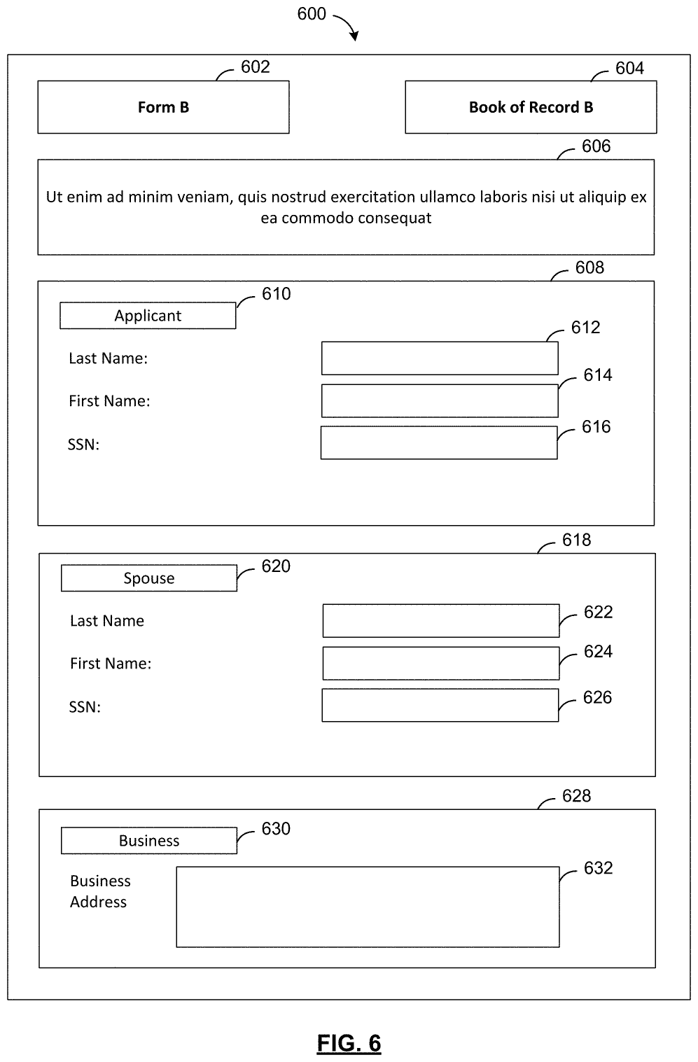

Referring next to FIGS. 5-6, there are form diagrams for the BOR A 500 (FIG. 5) and the BOR B 600 (FIG. 6). These two BOR forms are candidate forms sent for mapping by the electronic form management system. The BOR A and the BOR B may be different financial institutions with different input validation rules, and different business validation rules.

In another embodiment, the candidate forms sent for mapping may be for an electronic personal health records system (not shown), for instance the candidate forms may be a patient information form, a referral to a specialist including patient information, and an order for, or request for results from, a medical test.

Like numbers for form fields in FIGS. 5-6, 11-12, 15A, 16-17, and 20-21 identify like user data fields. It is understood that the types of user input fields selected in FIGS. 5-6, 11-12, 15A, 16-17, and 20-21 are merely representational examples, and there may be many more fields included on a candidate form, and a generated instance of an electronic form generated by the electronic form mapping system.

Referring next to FIG. 5, there is a form diagram 500 for the BOR A. The form 500 may be a form mapping candidate (that is, it may be submitted to the electronic form management system for mapping and electronic representation). The form 500 has a form identifier 502, a BOR identifier 504, contract clauses 506, an applicant information pane 508, a spouse information pane 518, and an other information pane 528. The form fields on the form 500 may have input validation rules associated with them. While text boxes are shown for form 500, the user input fields may be in the form of select boxes, text areas, radio buttons, sliders, or any user input control. The text boxes shown for form 500 may simply be identified locations on a paper form for a user to write in the relevant piece of information.

The form identifier 502 may be a form type identifier, a form title, an image, a logo, etc. The BOR identifier 504 may be a BOR name, a BOR logo, etc.

The form 500 may be a paper form, an electronic form (such as a fillable PDF form), or a software-based form. A candidate software-based form may be a web form delivered to a user by web browser or using an application. Where candidate form A 500 is mapped, the form fields are mapped to data points within the structured data set associated with a user of the electronic form management system.

Contract language 506 may include contract clauses, information about a particular product or service of the BOR A, and contract language.

The applicant information pane 508 has an applicant label 510, a first name field 512, a last name field 514, and a social security number (SSN) field 516. Each of the fields 512, 514, and 516 correspond to a particular user input field such as a text box. The mapping of applicant information, including first name, last name, and SSN may be made from the field type of the candidate form to the structured data set, and may associate the field with particular elements of the structured data set. The mapping between the fields on a candidate form and the structured data set may be bidirectional, such that the fields on the candidate form identify element(s) of the structured data set and the element(s) of the structured data set each identify candidate electronic forms where they appear and are associated.

The spouse information pane 518 has a spouse label 520, spouse first name field 522, a spouse last name field 524, and a spousal SSN field 526. Each of the fields 522, 524, and 526 may be a text box. The mapping of spouse information, including first name, last name, and SSN may be made from the field type of the candidate form to the structured data set, and may associate the field with particular elements of the structured data set. The mapping of spouse pane 518 may involve an association with a different structured data set for the spouse user than the applicant pane 508.

The other information pane 528 has an other information label 530, an alternate telephone number field 532, and an alternate email field 534.

Referring now to FIG. 6, there is a form diagram 600 for the BOR B. The form 600 may be a form mapping candidate (that is, it may be submitted to the electronic form management system for mapping and electronic representation). The form 600 has a form identifier 602, a BOR identifier 604, contract clauses 606, applicant pane 608, a spouse information pane 618, and a business information pane 628. The form fields on the form 600 may have input validation rules associated with them. While text boxes are shown for form 600, the user input fields may be in the form of select boxes, text areas, radio buttons, sliders, or any user input control. The text boxes shown for form 600 may simply be identified locations on a paper form for a user to write in the relevant piece of information.

The candidate form 600 may be a paper form, an electronic form (such as a fillable PDF form), or a software-based form. A candidate software-based form may be a web form delivered to a user by web browser or using an application. Where candidate form B 600 is mapped, the form fields are mapped to data points within the structured data set associated with a user of the electronic form management system.

Contract language 606 may include contract clauses, information about a particular product or service for the BOR B, and contract language.

Form 600 for the BOR B shows a form having a different compliance requirement of last name field 612 displayed in order first before first name field 614. Similarly, in spouse pane 618, spouse last name 622 is displayed first in order before spouse first name 624.

Business pane 628 has business identifier 630, and business address field 632.

As between form A 500 and form B 600, it is understood that form mapping of the fields in each would result in the applicant first name field for each form mapping to the same element of the structured data set. Similar form mappings would also be made between applicant last name for each of forms A 500 and B 600, applicant SSN, etc. A bidirectional mapping would associate the element of the structured data set to the applicant first name fields in both form A 500 and form B 600.

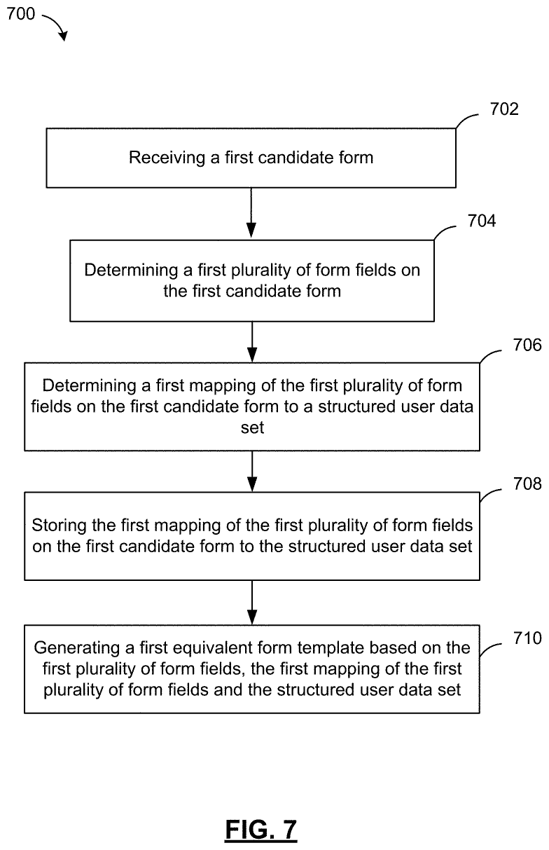

Referring to FIG. 7, there is a method diagram 700 for managing electronic forms including mapping form fields. At 702 a first candidate form is received. The candidate form may be in different forms, including a paper form, an electronic form (such as a fillable PDF), or another form. The first candidate form may be transmitted by an user to the electronic form management system for mapping. The first candidate form may include a plurality of form fields, and the form fields may be of different types and sizes. The candidate form may have contract clauses and other language.

At 704, a first plurality of form fields on the first candidate form are determined. Determining the first plurality of form fields may be done by a user who reviews the first candidate form and associates each field with an element of a structured data set. Alternatively, the first plurality of form fields may be mapped automatically using an Optical Character Recognition (OCR) algorithm. The output of the automatic form field determination may be submitted to a user for review. The determining a first plurality of form fields may involve determining an enumeration of the form fields on a form, determining the structure of fields on the form (including potential information hierarchies), determining the sequence of fields on the form, and determining visual elements of the form (such as images and logos).

At 706, a first mapping of the first plurality of form fields is determined from the first candidate form. The first mapping of the first plurality of form fields may have a plurality of individual field mappings from one or more fields on a first candidate form to one or more elements of the structured user data set. In this way, the first mapping represents a plurality of associations between the fields of the candidate form and the user data stored in the structured data set. The mapping may be used to generate an equivalent form template, and the equivalent form template may be combined with a structured data set to generate an instance of a form document. The mapping (or association) between the first plurality of form fields and the structured data set may be bi-directional, such that a field on an instance of the electronic form corresponds to at least one element of a structured data set, and an element of the structured data set corresponds to at least one field on at least one electronic form.

At 708, the first mapping of the first plurality of form fields on the first candidate form to the structured user data set may be stored in database 116 (see FIG. 1A). The first mapping may alternatively be stored together with the electronic form itself. A bi-directional mapping may mean an inverse first mapping is stored in the structured data set.

At 710, a first equivalent form template is generated based on the first plurality of form fields, the first mapping of the first plurality of form fields and the structured user data set. The first equivalent form template may be used to generate output, including intermediate documents and output documents, based on the structured user data set.

The method 700 may be applied to different candidate forms for a different BOR, or different types of forms for the same BOR, and in such situations, a second candidate form may be received.

A second plurality of form fields on the second candidate form may be determined. This second plurality of form fields may be generally similar to the first plurality of form fields, may have fewer fields, may have more fields, and may have different fields.

A second mapping may be determined from the second plurality of form fields on the second candidate form to a structured data set. This second mapping may map fields on the second candidate form to fields also mapped by the first mapping. In the case of a bi-directional mapping, the element of the structured data set may itself have an inverse map to the fields in the first candidate form and the second candidate form.

The second mapping of the second plurality of form fields may have a plurality of individual field mappings from one or more fields on a second candidate form to one or more elements of the structured user data set.

The second field mapping may be stored in the same manner as the first field mapping.

A second equivalent form template may be generated based on the second plurality of form fields, the second mapping of the second plurality of form fields and the structured user data set.

The first equivalent form template and the second equivalent form templates generated by the electronic form management system may have at least some fields in common, and those fields map to the same element in the structured data set. The first equivalent form template and the second equivalent form template may be different form types, for example, a retirement account application and a checking account application.

Referring to FIGS. 8-10 there is described the process of formless data capture, intermediate document generation, and form document generation.

Referring to FIG. 8, there is a user interface 800 diagram for managing electronic forms. The user interface 800 is the user interface for the formless data capture 326 (see FIG. 3). In the data collection step of FIG. 3, user information is collected from a client portal 302, an advisor portal 304, a CRM system 306 and a custom application API endpoint 308 collects data about a particular user or a plurality of users. Remaining user information that is required after the data collection (FIG. 3) is collected using formless data capture in the user interface 800. Alternatively, remaining user information may be collected on a rendition of the equivalent form template.

Referring back to FIG. 8, the formless data capture interface 800 is used by a user for data normalization and for a user to input outstanding information required to complete an instance of a form document for submission to a BOR. The outstanding information is submitted by a user in a plurality of input fields 804, 808, 812, 814, 816, 818. A user completes the plurality of input fields using an input device on their system, and provides a plurality of user inputs. The formless data capture interface 800 has a salutation field 802 with a plurality of salutation options 804 shown as radio buttons, a first name label 806, a first name field 808, a submit button 810, a middle initial field 812, a last name field 814, a date of birth field 816 in the form of a date picker, a phone number field 818, a marital status field 820 in the form of a radio button, and a language of correspondence input 822 in the form of a radio button.

A user may make a request to the electronic form management system, and any outstanding information may be determined after the initial data collection. The determination of outstanding information (normalization) may be the remaining required information collected from the user in the formless data capture interface as required.

The electronic form management system may operate to automatically generate equivalent application forms for loan applications, insurance applications, bank account applications, brokerage applications, etc. In such examples, the electronic form management system may allow for comparison shopping by a user.

In a different example, a user may wish to create a second account type after initially creating a first account type. The data collection, and existing structured data set for such a user may reduce the amount of information required during the formless data capture.

In the formless user interface 800, a user may provide user inputs using a variety of controls, for example a textbox or radio button. The field information displayed during the formless data capture may be prepopulated from the data collection. The provided user inputs may create or update elements of the structured data set for the user upon submission 810.

The fields in interface 800 include information related to three different types of fields used to generate instances of form documents: mandatory fields, conditional fields, and optional fields.

The mandatory fields are the set of fields required by the at least one form document instance for submission. These generally include primary information about the user, including their name, address, and date of birth. The mandatory fields may also include information required for opening a particular account, such as gross annual income.

The conditional fields may be presented in the formless data capture interface 800. These conditional fields may be contextual, and may update and change based on the data collection, or user input during the formless data capture itself. For example, if a user selects a marital status 820 of married, then conditional fields related to the first name, last name, and SSN of the user's spouse may be presented in the interface 800 and required for completion.

The optional fields are the set of extra information that may be provided by the user if so desired. For example, a user may provide their business address, alternate telephone number or alternate email address.

In one embodiment, a user of the electronic form management may have the option to produce an instance of an electronic form document with a configurable level of details. For example, a user configuration option may be used by a user to generate an instance of an electronic form document in a particular view type. The user configuration options may include a ‘full’ view, a ‘compact’ view and an ‘intermediate’ view. The ‘full’ view type may include all information, including all optional fields. The ‘compact’ view type may include only mandatory fields. The ‘intermediate’ view type may include mandatory and conditional fields. The view types may be customizable by a user.

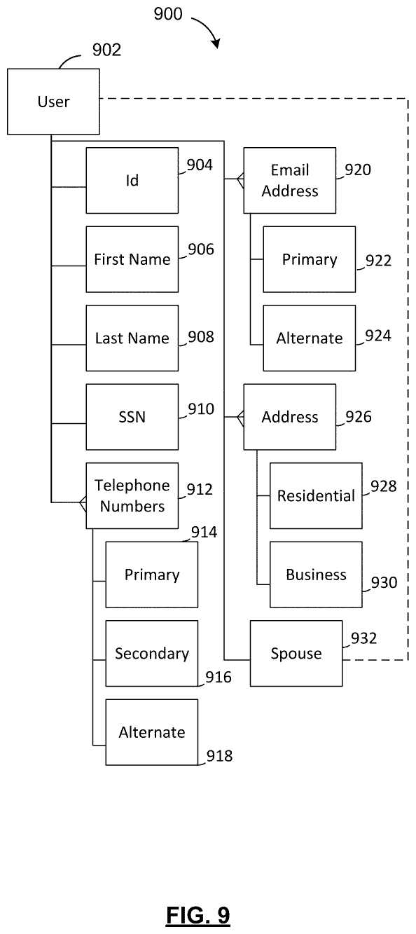

Referring to FIG. 9, an object relationship (OR) diagram 900 for managing electronic forms is shown. The OR 900 for a user may be a schema representation of the structured data set that is the SSOT in the electronic form management system. The OR 900. A structured user data set 900 has a plurality of elements in a hierarchy that form a schema. The schema representation is used to define the structured data set for each user. a user 902 has an ID 904, a first name 906, a last name 908, a SSN 910, at least one phone number 912, at least one email address 920, at least one address 926, and optionally a spouse 932 referring to another user.

The at least one phone number 912 may be a primary number 914, a secondary number 916, or an alternate number 918. The at least one email address 920 may be a primary email address 922 or an alternate email address 924. The at least one address 926 may be a residential address 928 or a business address 930.

The OR model 900 may represent a schema of database 116 (see FIG. 1A). The OR model 900 may be provided as a structured data set, in a format such as JSON or CSV.

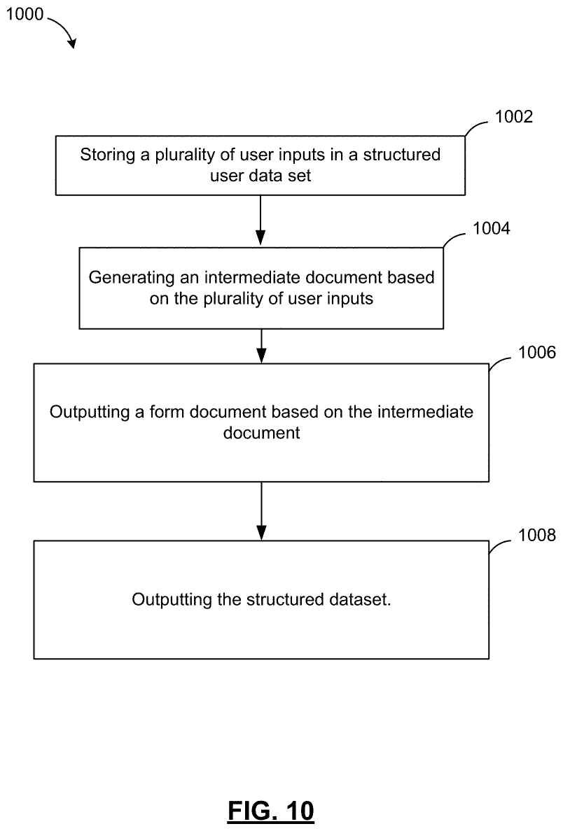

Referring to FIG. 10, there is a method diagram for managing electronic forms that may be used to generate form output. At 1002 a plurality of user inputs are stored in a structured user data set. These user inputs may be collected using the formless data capture interface of FIG. 8. The user inputs may also be collected during data collection. The user inputs may update an existing structured data set in a database, or the user inputs may create a new structured data set in the database.

The method 1000 may be performed on form server or the web server of the electronic form management system. Alternatively, the method 1000 may be performed partially on the form server and partially on the web server of the electronic form management server.

At 1004, an intermediate document is generated based on the plurality of user inputs. The intermediate document may be generated using an equivalent form template and the plurality of user inputs.

The intermediate document may be generated using an equivalent form template and a form mapping. The intermediate document may be a document in a markup language such as HTML or XML.

The generation of the intermediate document may involve rendering user data in a structured data set based on an equivalent document. The equivalent document has fields corresponding to elements of user data in the structured data set. The fields on the equivalent document may have categories, such as a mandatory category, a conditional category, and an optional category. The categories may determine the field presentation on the equivalent document.

At 1006, a form document based on the intermediate document is rendered. This output form document, such as a PDF document, may be generated from the intermediate document. The intermediate document may be generated in a form that is visually similar to the output form document. The form document may be encrypted or digitally signed, such as with a digital identifier or a certificate.

At 1008, the associated structured data set is output. The structured data set may be output in a format such as JSON or XML. The structured data set is output in conjunction with the form document, and reflects a SSOT for the contents of the form document.

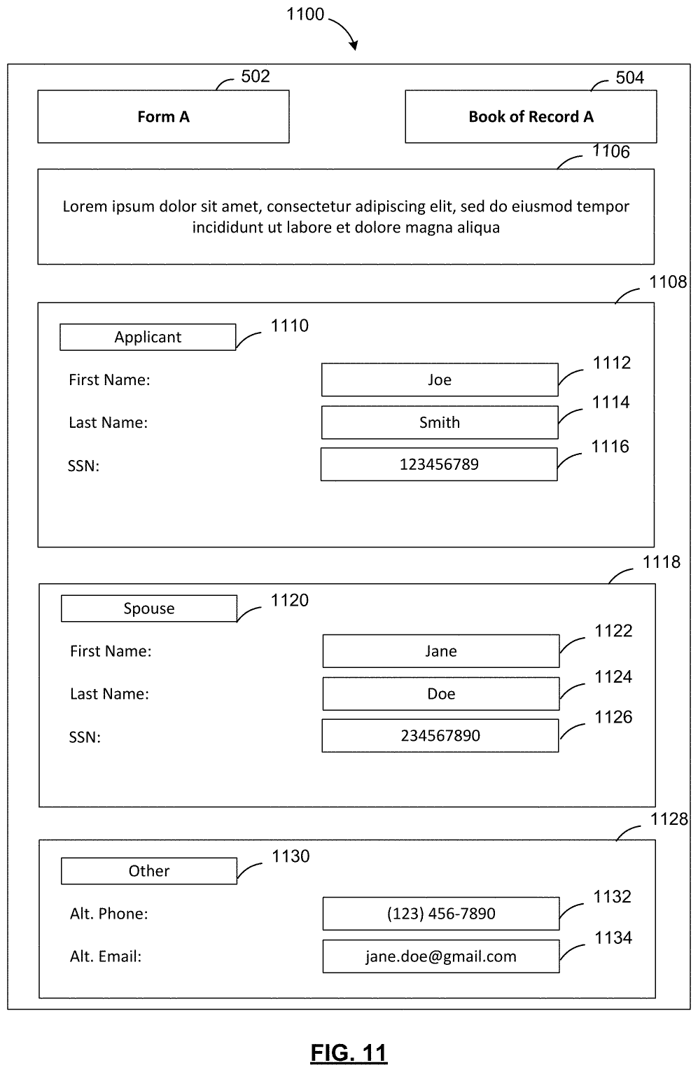

Referring to FIGS. 11-14, the generation of multiple form documents is described, including the generation of documents for the BOR A and the BOR B. The generated form documents for each of the BOR A and the BOR B may be generally consistent with one another, but may have different form mappings, a different equivalent form template and different business validation rules for a BOR.

Referring to FIG. 11 there is an example instance of a form document 1100 for the BOR A. Form document 1100 may be an intermediate form or a form document for output. Form document 1100 may visually correspond to the candidate form 500 in FIG. 5. In the form document 1100, a user Joe Smith has completed data collection and formless data capture to provide a plurality of user inputs. The plurality of user inputs for Joe Smith are stored in a structured data set. The instance of the form document 1100 may be generated based upon the equivalent form template for the BOR A and the structured data set. As shown, form document 1100 is on a single page, but it is recognized that the form document may span pages, and may have more information than the fields displayed in FIG. 11.

Contract language 1106 may include contract clauses, information about the BOR A's products or services, and may include standard form contract language. The contract clauses 1106 may be the same for each user, or may be contextually sensitive to user input data related to a particular user. For example, in form document 1100, there may be particular contract language related to the legal relationship of the applicant with user's spouse as detailed in spouse pane 1118 that may not appear for a user who does not have a spouse.

Form document 1100 may be generally compliant with the BOR A's internal compliance rules for document submission.

The instance of form document 1100 has a completed applicant pane 1108, including applicant label 1110, first name field 1112, last name field 1114 and SSN field 1116. The fields of the applicant pane may be categorized as mandatory fields.

The instance of form document 1100 has a completed spouse pane 1118 including spouse label 1120, first name field 1122, last name field 1124, and SSN field 1126. The fields of spouse pane 1118 may be categorized as conditional fields.

The instance of form document 1100 has an other pane 1128, including an other label 1130, an alternate telephone number field 1132, and an alternate email field 1134. The fields of other pane 1128 may be categorized as optional fields.

In one embodiment, a user of the electronic form management system may select a view type for the instance of the form document 1100 that is generated. This view type may allow for a ‘compact’ view of the instance of form document 1100 that includes only mandatory type fields, or alternatively, it may allow for an ‘full’ view that includes all fields even if they are empty.

The form document 1100 may be output to a BOR, for example the form document may be sent using an API endpoint, by File Transfer Protocol (FTP) transfer, by email, or by another transfer means. The form document 1100 may be encrypted in storage, and may be encrypted separately during network transit, for example, using Hyper-Text Transfer Protocol Secure (HTTPS).

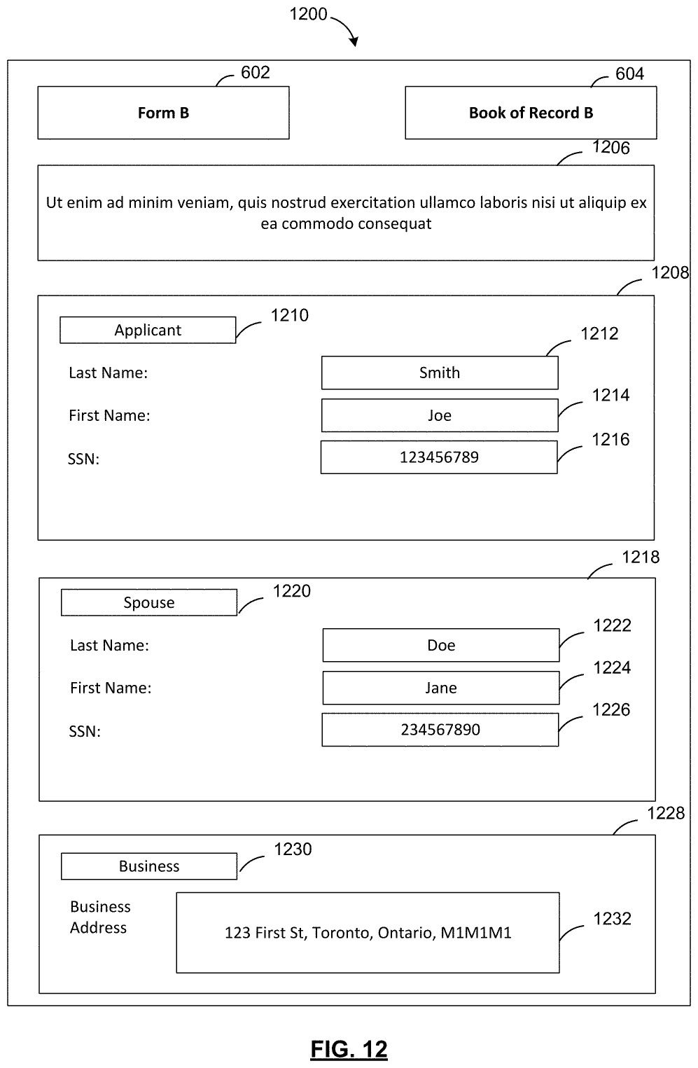

Referring to FIG. 12, there is an example instance of a form document 1200 for the BOR B. Form document 1200 may be an intermediate form or a form document for output. Form document 1200 may visually correspond to the candidate form 600 in FIG. 6. It will be observed that the field contents of form document 1100 and 1200 are consistent. Form document 1200 may be generally compliant with the BOR B's internal compliance rules for document submission. As shown, form document 1200 is on a single page, but it is recognized that the form document may span pages, and may have more information than the fields displayed in FIG. 12.

In one embodiment, a user of the electronic form management system may select a view type for the instance of the form document 1200 that is generated. This view type may allow for a ‘compact’ view of the instance of form document 1200 that includes only mandatory type fields, or alternatively, it may allow for an ‘full’ view that includes all fields even if they are empty.

Contract language 1206 may include contract clauses, information about the BOR B's products or services, and may include standard form contract language. The contract clauses 1206 may be the same for each user, or may be contextually sensitive to user input data related to a particular user. For example, in form document 1200, there may be particular contract language related to the user's spouse as detailed in spouse pane 1218 that may not appear for a user who does not have a spouse.

The instance of form document 1200 has a completed applicant pane 1208, including applicant label 1210, first name field 1214, last name field 1212 and SSN field 1216. The fields of the applicant pane may be categorized as mandatory fields.

The instance of form document 1200 has a completed spouse pane 1218 including spouse label 1220, first name field 1224, last name field 1222, and SSN field 1226. The fields of spouse pane 1218 may be categorized as conditional fields.

The instance of form document 1200 has a business pane 1228, including a business label 1230 and a business address field 1232. The fields of business pane 1228 may be categorized as optional fields.

It is observed that, as between form document 1100 and form document 1200 there are several distinguished elements. The BOR B requires applicant pane 1208 and spouse pane 1218 to provide information in last name first format, distinguished from the BOR A. The BOR B further displays a business pane 1228 instead of other pane 1128. As between the BOR A and the BOR B there may be further distinguishing features, such as different input validation rules and different business validation rules.

The form document 1200 may be output to a BOR, for example the form document may be sent by an API endpoint, by File Transfer Protocol (FTP) transfer, by email, or by any other transfer means. The form document 1200 may be encrypted in storage, and may be encrypted separately during network transit, for example, using Hyper-Text Transfer Protocol Secure (HTTPS).

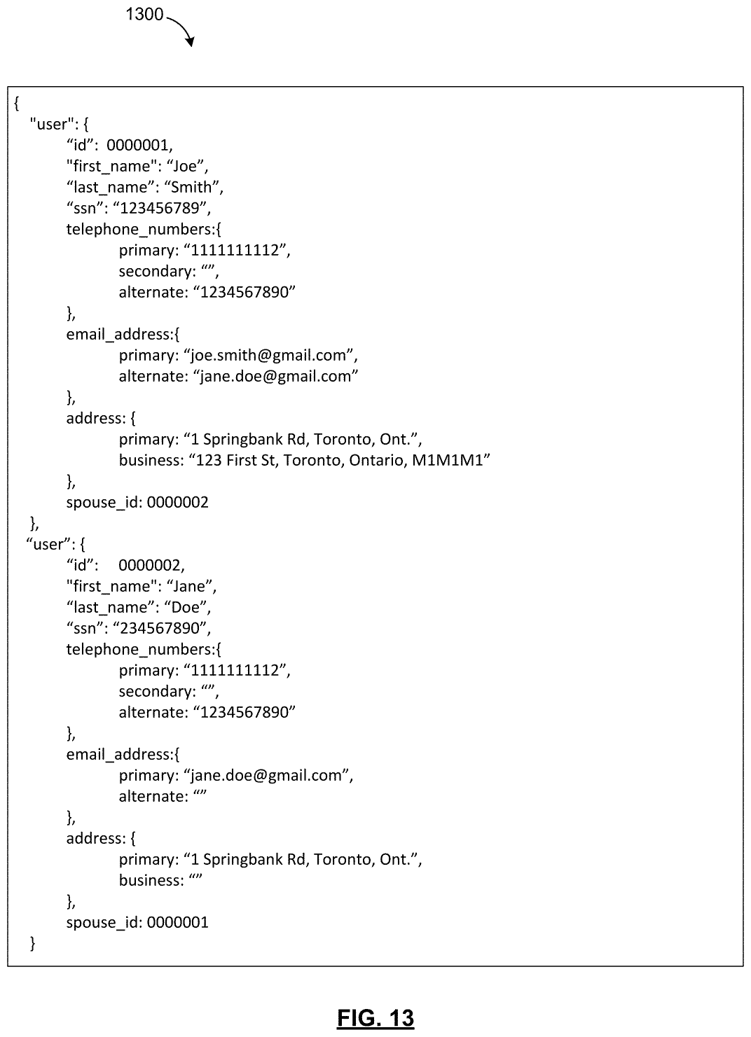

Referring to FIG. 13, there is shown an example of a structured data set 1300 for managing electronic forms. The structured data set 1300 corresponds to form document 1100 and form document 1200. As shown, structured data set 1300 may be in JSON, however it is understood that another format such as XML may be used.

The structured data set 1300 may be output at the same time as the output of form document 1100 and form document 1200. The structured data set 1300 may be a SSOT for form document 1100 and form document 1200.

The structured data set 1300 may be output to a BOR, for example it may be sent using an API endpoint, by File Transfer Protocol (FTP) transfer, by email, or by another transfer means. The structured data set 1300 may be encrypted in storage, and may be encrypted separately during network transit, for example, using Hyper-Text Transfer Protocol Secure (HTTPS).

The structured data set 1300 may have the same schema as the object model found in FIG. 9.

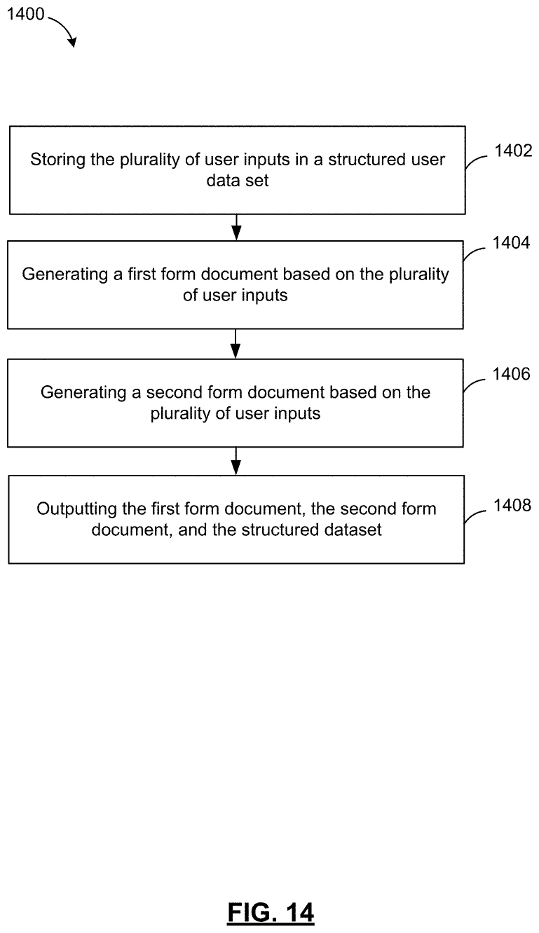

Referring to FIG. 14, there is a method diagram 1400 for managing electronic forms. The method diagram 1400 describes the method of generating a first form document and a second form document, for example, the first form document 1100 in FIG. 11 and the second form document 1200 in FIG. 12. The first form document may be for a first BOR or first vendor, and the second form document may be for a second BOR or second vendor. The method 1400 may be performed on the form server or the web server of the electronic form management system. Alternative, the method 1400 may be performed partially on the form server and partially on the web server of the electronic form management server.

At 1402, a plurality of user inputs are stored in a structured data set. These user inputs may be received by data collection, or by formless data capture (normalization). A user may request data entry, and a data entry page having a plurality of fields may be presented to the user. The submission of the data entry page may transmit a plurality of user inputs corresponding to the plurality of fields, where each user input has a key and a value corresponding to the key.

At 1404, a first form document is generated based on the plurality of user inputs. The first form document may be generated from the plurality of user inputs, an equivalent form template, and a first form mapping. The first form document may be an intermediate document (for example, in HTML or XML format) or an output document (for example, in PDF format).

The first form may have a first plurality of validation rules associated with it. These input validation rules may determine the requirements of user input fields on the form. The input validation rules may describe characteristics such as the minimum length of data, the maximum length of data, the required presence or required absence, and the input type (for example, numeric or alphabetical).

The first plurality of validation rules may also include business validation rules for a BOR. These may include particular business requirements specified by the BOR. For example, a BOR may require that a user's gross annual income be above a threshold to apply for a particular product or service.

The first plurality of validation rules may be executed to determine a first validation result. Such a validation result may aid a user in understanding particular user input requirements.

At 1406, a second form document is generated based on the plurality of user inputs. The second form document may be generated from the plurality of user inputs and a second form mapping. The second document may be an intermediate document (for example, in HTML or XML format) or an output document (for example, in PDF format).

The second form may have a second plurality of validation rules associated with it. These validation rules may determine the requirements of user input fields on the form. The validation rules may describe characteristics such as the minimum length of data, the maximum length of data, the required presence or required absence, and the input type (for example, numeric or alphabetical).

The second plurality of validation rules may also include business validation rules for a BOR. These may include particular business requirements specified by the BOR. For example, a BOR may require that a user's gross annual income be above a threshold to apply for a particular product or service.

The second plurality of validation rules may be executed to determine a second validation result. Such a validation result may aid a user in understanding particular user input requirements.

In the case of either or both of the first form document and the second form document, the intermediate document may be human readable format (such as Unicode or ISO-8859), or may be in a format not easily readable by a human (such as a binary format).

In the case of either or both of the first form validation rules or the second form validation rules, the rules may be simple or compound (i.e. many may be combined to determine the requirements for user data input into the field).

At 1408, the first form document, second form document, and the structured data set are output. In one case, the first form document is transmitted to a first BOR accompanied by the structured data set, and the second form document is transmitted to a second BOR accompanied by the structured data set. The output may be provided by an API endpoint, by email, etc. The output may be performed based on an incoming request from a BOR (pull), or alternatively, may be transmitted to a BOR based on a user's completion of required information (push).

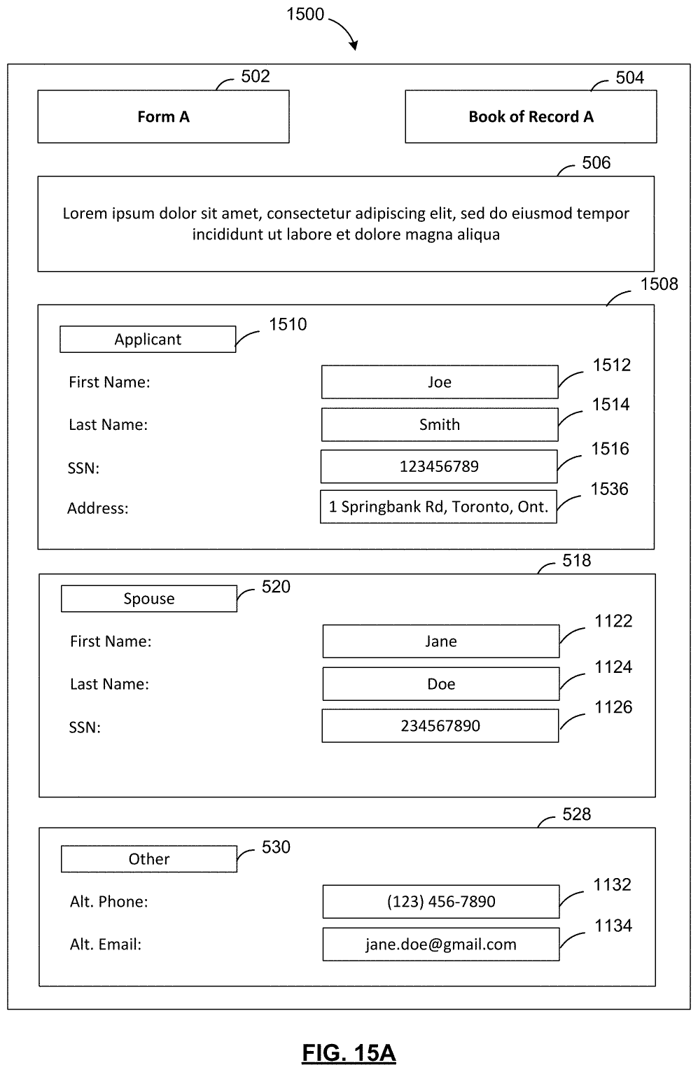

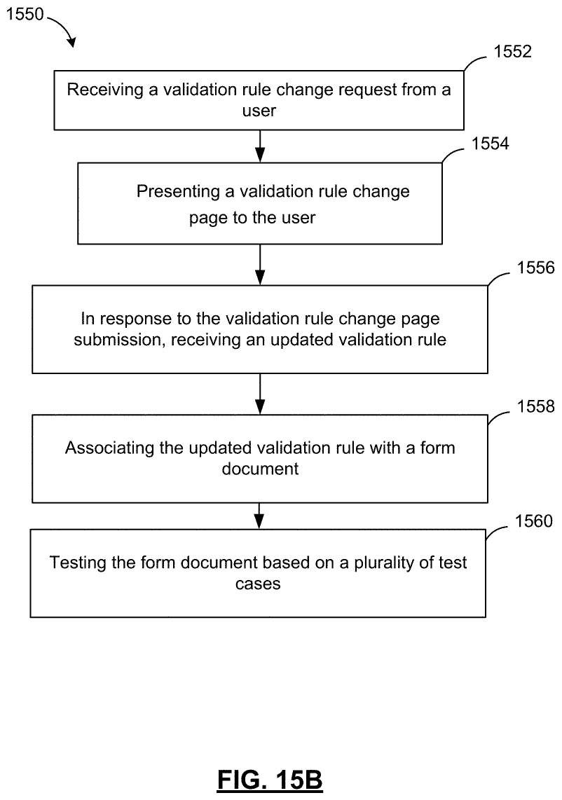

Referring to FIG. 15A there is an example instance of a form document 1500 for the BOR A. The electronic form management system may operate to streamline the process of validation rule changes (including both input validation rules and business validation rules), specifically, changes to validation rules governing fields on the generated form documents.

This example instance of a form document 1500 reflects a validation rule change to the form document 1100 in FIG. 11 to add the address field 1536 to applicant pane 1508. Validation rule changes may take other forms, including changing the presence or absence of data on a generated form document, changing the field type, setting range limits on a field, changing the layout of a form document, changing conditional fields and the conditional logic for said conditional fields, changing optional fields, changing business fields, etc.

Referring to FIG. 15B there is a method diagram 1550 for managing electronic forms. This method describes a method for testing of validation rules change such as the validation rule change in FIG. 15A.

The method 1550 may be performed on the form server, the test server or the web server of the electronic form management system. Alternative, the method 1550 may be performed partially on the form server, partially on the test server, and partially on the web server of the electronic form management server.

At 1552, a validation rule change request is received from a user. The user may make such a request by requesting to edit an electronic form on the electronic form management system.

At 1554, a validation rule change page is presented to the user to edit the electronic form.

At 1556, the user may submit the validation rule change page, and in response to the validation rule change page submission, an updated validation rule is received for the electronic form. In previous form management systems, such a change requires extensive testing of the validation rule change to ensure that compliance with the BOR is maintained.

At 1558, the updated validation rule is associated with the electronic form.

At 1560, the electronic form document is tested based on the updated validation rule. This testing may involve executing test cases against the updated electronic form document. Testing may be performed with a known set of test cases, each test case having test code for performing the test, test input data, and an expected test output. The testing may be performed against the intermediate document generated by the electronic form management system.

The set of test cases may be stored in a database or on disk in files.

The intermediate document is provided in a markup format, and may be testable using document selectors such as Cascading Stylesheet Selectors (CSS Selectors) or using XML Path Language Selectors (XPath Selectors).

The intermediate document may also be testable using CSS and XPath Selectors to test the presence or absence of a particular element, the visibility of a particular element, the ordering of elements within the intermediate document, etc. The CSS Selectors or XPath Selectors may identify intermediate document elements using an id, or key value.

To execute the test, the test server may, for each test case, execute the test code associated with the test case (which may include such CSS Selectors or XPath Selectors), and may compare the test case expected result with the value in the intermediate document identified using a document selector. Based on the result of the test code execution, a positive test result will be output if and only if the expected value matches the value of the intermediate document field associated with the test key. The matching criteria may be determined by the test code, and may include testing presence or absence of an element, or comparing the value of the element.

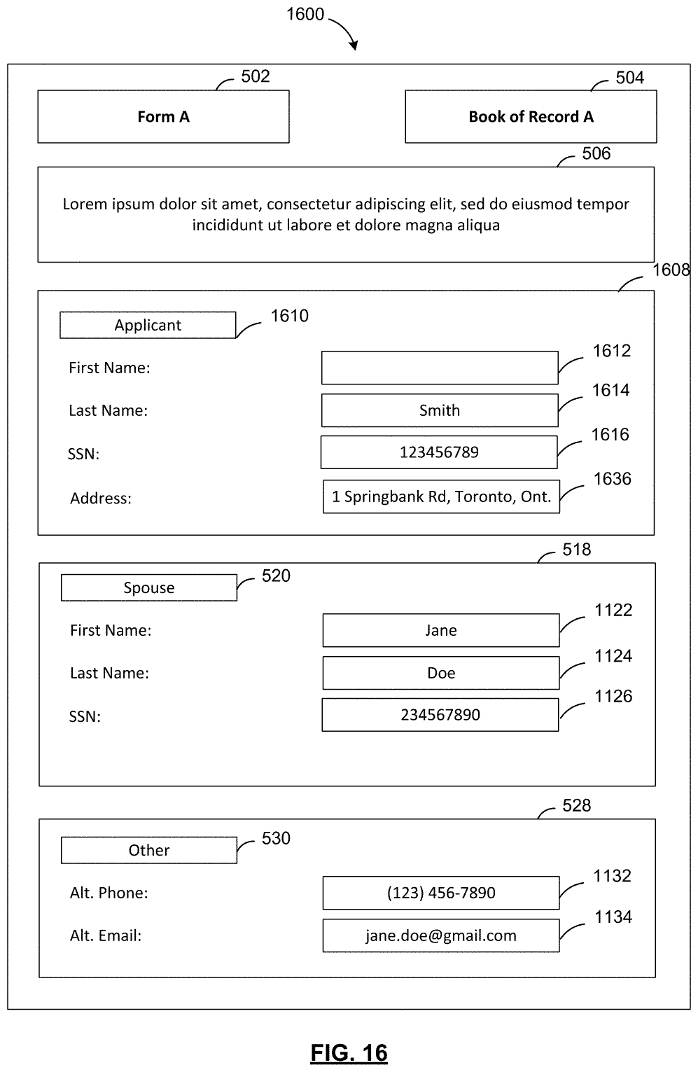

Referring now to FIG. 16, there is an example instance of a form document 1600 for the BOR A. In the example instance of the form document 1600, a validation rule change has been applied to the BOR A form 1500 from FIG. 15A. As a result of the validation rule change, form documents generated using the electronic form management system that include the validation rule may have error conditions that result in failed compliance with the BOR A.

In the case of form document 1600, applicant pane 1608 may not be correctly populated with the first name field 1612 (it appears blank). While other fields in the applicant pane, such as last name field 1614, SSN field 1616 and address field 1636 appear correctly populated, the generated instance of the form document 1600 is not in compliance with the BOR A rules because first name field 1612 is not populated.

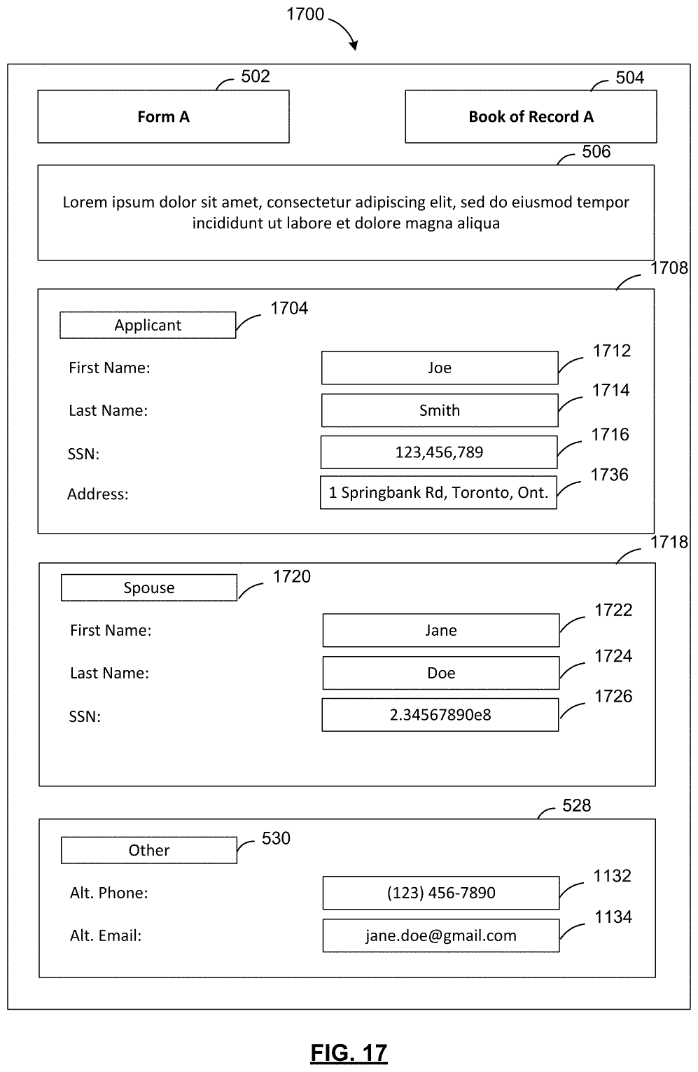

Referring now to FIG. 17, there is an example instance of a form document 1700 for the BOR A. In the example instance of the form document 1700, a validation rule change has been applied to the BOR A form 1500 from FIG. 15A. As a result of the validation rule change, form documents generated using the electronic form management system that include the validation rule may have error conditions that result in failed compliance with the BOR A.

In the case of form document 1700, there are several document generation errors including that: applicant pane 1708 is not correctly populated, and spouse pane 1718 is not correctly populated. In the case of applicant pane 1708, the SSN field 1716 appears as a numeric value formatted with commas. In the case of the spouse pane 1718, the SSN field 1726 is formatted as a decimal number in scientific notation. In the case where compliance with rules of a BOR requires a specific number format for the SSN fields, these errors may result in non-compliance with the BOR rules.

While other fields in applicant pane, such as first name field 1712, last name field 1714, and address field 1736 appear correctly populated, the generated instance of the form document 1700 is not in compliance with the BOR A rules because the applicant SSN field 1712 and spouse SSN field 1726 are not correctly formatted.

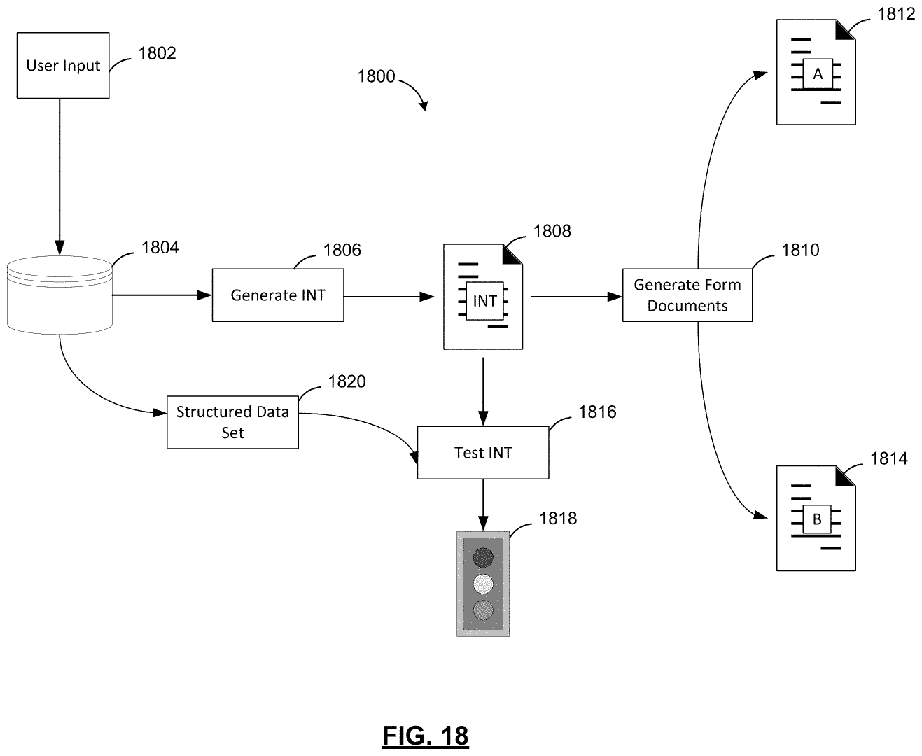

Referring now to FIG. 18, there is a system diagram 1800 for managing electronic forms. The system diagram 1800 shows the testing of validation rule changes as described in the method in FIG. 15B.

Test cases are created by test engineers, and stored in a database. The test cases may include test code that may be run by a testing server. The test code may include document selectors such as CSS Selectors or XPath Selectors. Each test case may compare the intermediate document 1808 with the contents of the structured data set 1820 stored in database 1804 to determine whether a positive test result or negative result should be output. Alternatively, a test case may store an expected outcome to compare with the value in the intermediate document in the test code itself.

User input data 1802 is stored in database 1804. This may include data collected during data collection and formless data capture. This data may be stored in a structured data format such as JSON or XML. An intermediate document 1808 is generated by form server at 1806. There may be multiple intermediate documents 1808 generated if form documents are to be generated for multiple BORs.

Testing of the electronic form document 1816 is conducted using test cases stored in the database. The output of the plurality of test cases 1818 may be a positive test result or a negative test result. Optionally, the plurality of test cases 1818 may additionally have a caution test result referring to a test result that is of concern, but not negative.

An output form document may be rendered at 1810 based on the at least one intermediate documents 1808. The form document A 1812 is generated for the BOR A, and form document B 1814 is generated for the BOR B. Each of the form document A 1812 and form document B 1814 may be provided with structured data set 1820 for a particular user, with the structured data set 1820 being a SSOT for the form documents.

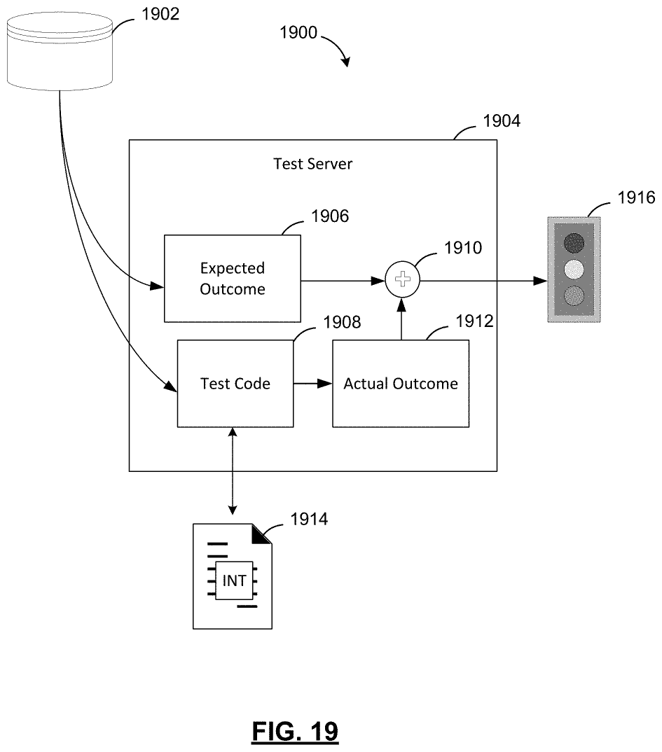

Referring to FIG. 19, there is a system diagram 1900 showing more detail of the testing 1816 in FIG. 18. Database 1902 has a structured data set that may be used as as the expected outcome 1906 for a test case. The test server 1904 runs the test code 1908 to determine an actual outcome 1912 from an intermediate document 1914. The test code 1908 may be stored in database 1902, or may be stored on disk.

The expected outcome 1906 and the actual outcome 1912 are compared at 1910 to determine a test result 1916. The expected outcome 1906 may be an identified element of the structured data set, or it may be provided within the test code itself. The expected outcome 1906 may be a single element, or a grouping of elements. The test comparison 1910 may test value equality of the actual outcome. The test comparison 1910 may test the metadata (or other non-visible elements) of the actual outcome. The test comparison 1910 may involve testing presence or absence of an element or elements. Similarly, the test comparison 1910 may test the ordering of elements. The test comparison may use document selectors such as CSS Selectors and XPath Selectors.

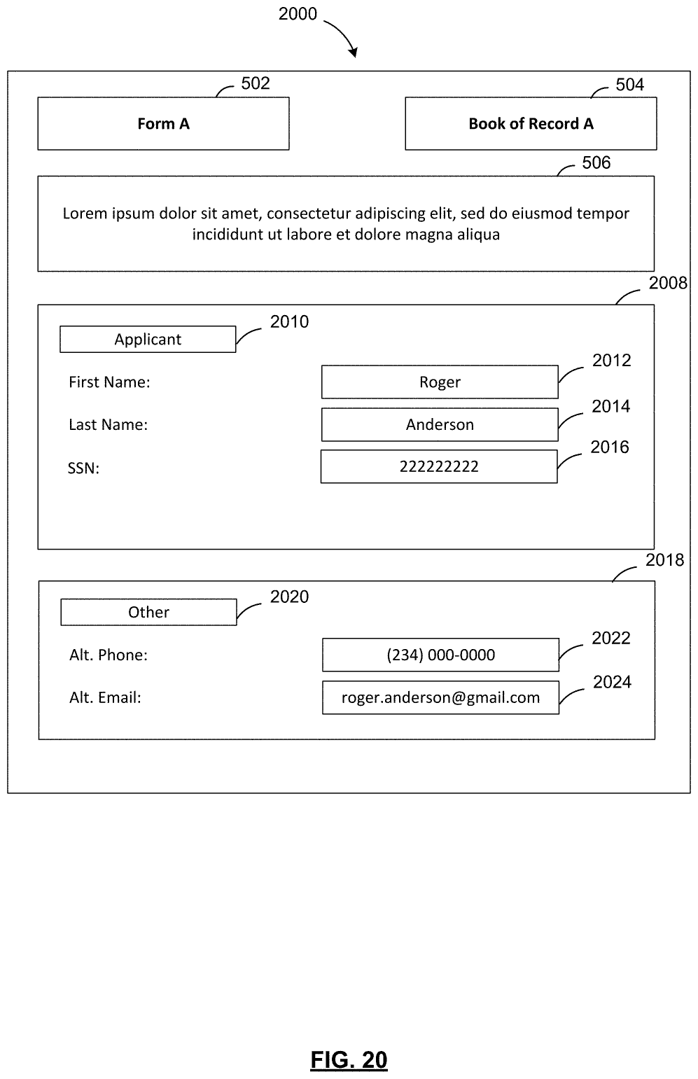

Referring to FIG. 20, there is an example instance of a form document 2000 for the BOR A. The form instance 2000 has applicant pane 2008 and other pane 2018. Applicant pane 2008 has applicant label 2010, first name field 2012, last name field 2014, and SSN field 2016. Other pane 2018 has other label 2020, alternate phone field 2022, and alternate email field 2024.

It is noted that the applicant in form instance 2000 has no spouse, and thus the spouse pane is not displayed in the output during form instance generation. The spouse pane, and related information is an example of a conditional field type that is displayed in generated documents only as required. However the user in the example in FIG. 20 does have optional information provided in the other pane 2018.

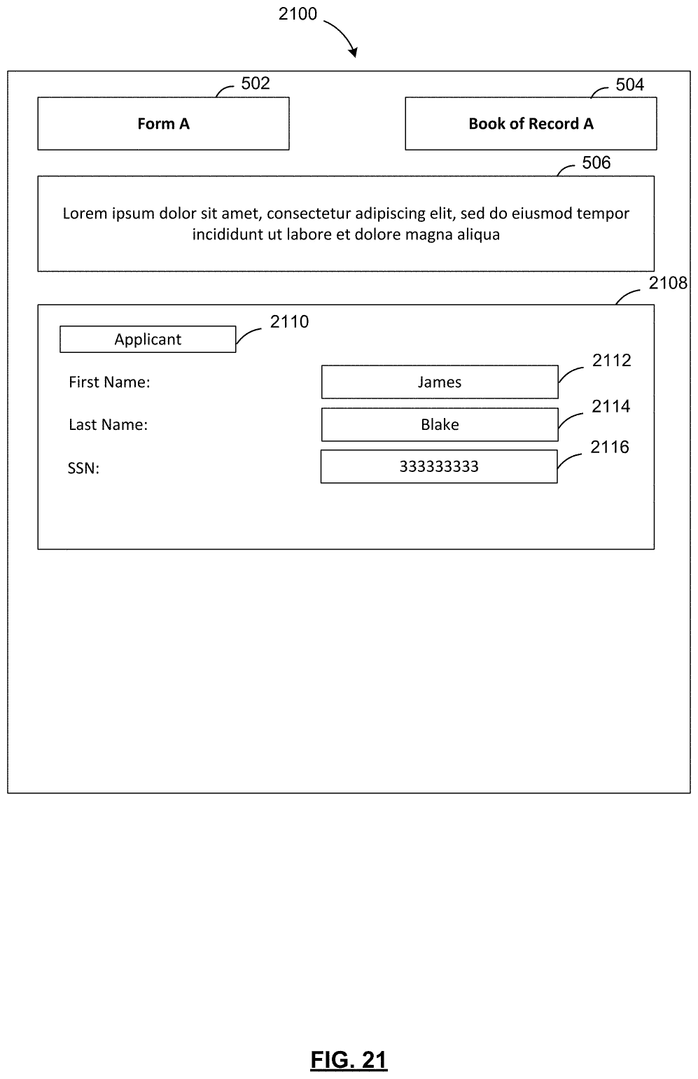

Referring to FIG. 21, there is an example instance of a form document 2100 for the BOR A. The example user in form document 2100 has mandatory information, but no conditional spouse information nor any optional information provided in the other pane.

Various embodiments have been described herein by way of example only. Various modification and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

We claim:

1. A method of electronic form management, comprising:
receiving a first candidate form;
determining a first plurality of form fields on the first candidate form;
determining a first mapping from the first plurality of form fields on the first candidate form to a first plurality of elements in a structured user data set; and
generating a first equivalent form template based on the first plurality of form fields, the first mapping of the first plurality of form fields and the structured user data set.

2. The method of claim 1, further comprising:
receiving a second candidate form;
determining a second plurality of form fields on the second candidate form;
determining a second mapping from the second plurality of form fields on the second candidate form to a second plurality of elements in the structured user data set;
generating a second equivalent form template based on the second plurality of form fields, the second mapping of the second plurality of form fields and the structured user data set; and
wherein the first mapping has at least one of the first plurality of form fields on the first equivalent form template mapped to a first element in the structured user data set and the second mapping has at least one of the second plurality of form fields on the second equivalent form template mapped to the first element in the structured data set.

3. The method of claim 2 further comprising:
storing the first mapping of the first plurality of form fields on the first candidate form to the plurality of elements in the structured user data set; and
storing the second mapping of the second plurality of form fields on the second candidate form to the plurality of elements in the structured user data set.

4. The method of claim 3 wherein the first mapping and the second mapping are stored in a database.

5. The method of claim 3, further comprising:
pre-populating a user data field in the second plurality of form fields based on the same user data element in the structured user data set.

6. The method of claim 5, wherein the first mapping of the first plurality of form fields on the first candidate form and the second mapping of the second plurality of form fields on the second candidate form are bidirectional mappings.

7. The method of claim 6, wherein the first equivalent form template and the second equivalent form template each have a same form type.

8. The method of claim 6, wherein the first equivalent form template and the second equivalent form template each have a different form type.

9. The method of claim 8, wherein the first equivalent form template is a new application form type and the second equivalent form template is a new account form type.

10. A system of electronic form management, comprising:
a memory;
a processor configured to:
receive a first candidate form;
determine a first plurality of form fields on the first candidate form;
determine a first mapping from the first plurality of form fields on the first candidate form to a plurality of elements in a structured user data set; and
generate a first equivalent form template based on the first plurality of form fields and the structured user data set.

11. The system of claim 10, further comprising:
the processor further configured to:
receive a second candidate form;
determine a second plurality of form fields on the second candidate form;
determine a second mapping from the second plurality of form fields on the second candidate form to a structured data set;
generate a second equivalent form template based on the second plurality of form fields and the structured user data set; and
wherein the first mapping has at least one of the first plurality of form fields on the first equivalent form template mapped to a first element in the structured user data set and the second mapping has at least one of the second plurality of form fields on the second equivalent form template mapped to the first element in the structured data set.

12. The system of claim 11 further comprising:
store the first mapping of the first plurality of form fields on the first candidate form to the structured user data set in the memory; and
store the second mapping of the second plurality of form fields on the second candidate form to the structured user data set in the memory.

13. The system of claim 11, wherein at least one of the first plurality of form fields on the first equivalent form template and at least one of the second plurality of form fields on the second equivalent form template map to a same user data element in the structured data set.

14. The system of claim 12, further comprising:
the processor further configured to:
pre-populate a user data field in the second plurality of form fields based on the same user data element in the structured data set.

15. The system of claim 14, wherein the first mapping of the first plurality of form fields on the first candidate form and the second mapping of the second plurality of form fields on the second candidate form are bidirectional mappings.

16. The system of claim 15, wherein the first equivalent form template and the second equivalent form template each have a same form type.

17. The system of claim 15, wherein the first equivalent form template and the second equivalent form template each have a different form type.

18. The system of claim 17, wherein the first equivalent form template is a new application form type and the second equivalent form template is a new account form type.
